(19) United States
(12) Patent Application Publication
(10) Pub. No.: US 2006/0149658 A1
(43) Pub. Date: Jul. 6, 2006

(54) Construction contract bidding

(76) Inventor: Harold Blake Smith, Greensboro, NC (US)

Correspondence Address: MILLER PATENT SERVICES, 2500 DOCKERY LANE, RALEIGH, NC, 27606, US

(21) Appl. No.: 11/198,582

(22) Filed: Aug. 5, 2005

Related U.S. Application Data
(60) Provisional application No. 60/616,666, filed on Oct. 7, 2004.

(51) Int. Cl. G06Q 40/00

(52) U.S. Cl. 705/37

(57) ABSTRACT

In certain embodiments, a web based centralized electronic bidding system for construction bidding includes a database manager that stores contractor and subcontractor and supplier company identification information in a database. A bid processor is provided along with a mechanism for permitting any of the contractor, subcontractor and supplier to log onto the electronic bidding system. The bid processor receives a Requests for Proposals (RFP) document submitted electronically by a logged on contractor, assigns an identifier to the RFP document and associates the RFP document with company identifying information for the contractor that submitted the RFP document, to create a virtual RFP. A contact manager permits the logged on contractor to select at least one subcontractor or supplier for receipt of the virtual RFP. The bid processor further sends a notification to the selected subcontractor or supplier, so that the subcontractor or supplier will be notified of receipt of the virtual RFP upon logging on to the electronic bidding system. Additionally, this bidding system allows government agencies to verify “Good Faith” notification efforts on the part of general contractors to apprise subcontractors of RFPs by verifying send, receipt, and response data; and it compiles the growth of minority contractors to participate in non-government projects. This abstract is not to be considered limiting, since other embodiments may deviate from the features described in this abstract.

### CROSS REFERENCE TO RELATED DOCUMENTS

This application claims priority benefit of U.S. Provisional Patent Application Ser. No. 60/616,666 to Blake Smith, filed Oct. 7, 2004, which is hereby incorporated herein by reference. An appendix hereto contains a document entitled “Digital Bid Transfer in the Highway Construction Industry” by Blake Smith, the inventor named hereto, which explains migration theory. This appendix forms a part of this application and is hereby incorporated by reference.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

RFPs (Request for Proposals) and RBs (Response Bids, or Bids, or Bid Responses) are the standard mechanism used in the construction industry for obtaining quotes for services between contractors and subcontractors. These instruments are conventionally transferred in the commercial construction industry in two primary ways 1) faxed, or 2) as email attachments, and two secondary ways 1) stamped mail, or 2) individual phone calls. The structural restrictions of these systems, by their very nature, do not encourage a “best practices” bid environment. In spite of this, the current systems are almost exclusively used for handling commercial contracting RFPs and bids. One company even advertises that over 67% of the top 400 contractors use its solution for exchange of information via fax and/or email attachments. These systems, albeit in different ways, require General Contractors, subcontractors, and suppliers to keep pushing information through individual fax lines, or as individual email attachments. In some cases, the existing systems also require special hardware simply to run the large amount of document transfers, especially by the General Contractor.

Several of the problems associated with this type of system are illustrated in FIGS. 1 and 2. FIG. 1 illustrates a fax solution. A personal computer 10 operating as a word processor is used to generate an RFP document 14 that is transmitted using a fax machine 18 to a number of potential suppliers and subcontractors' fax machines 22, 26 and 30. In real world systems for commercial construction, there might be dozens or hundreds of potential subcontractors that are recipients of the fax. Also, while shown as a separate device, the fax machine or machines may be integrated into a personal computer system such as 10.

Hence, document RFPs, and associated documents are delivered to subcontractors and suppliers a page at a time via fax machine. This means that the documents are sent individually across separate telephone connections to every subcontractor and supplier recipient—this is very inefficient, time consuming, and expensive and tends to create a situation in which delivery of the RFP or RB is delayed to some recipients, and may not be delivered on-time, with clarity or to the right person. Static, PC based software programs have been developed to expedite the sending of mass RFPs to multiple recipients. However, even with such a PC based software system, this process can take a long time (often on the order of several days) to compile and send.

In putting together an RFP, General Contractors (GCs) often query their software “Contact Manager,” usually using CSI Codes (these are specific codes that define a subcontractor/supplier expertise in a particular construction area, i.e., electrical, pavement marking, theater seating, etc.) Then the documents have to be converted to a format that is fax-friendly. Paper, phone lines and machines are expensive to purchase maintain and operate. Many times the transmissions fail resulting in lost opportunity. Faxed bids lack security, because they lie around in a busy office environment totally exposed. Additionally, the transmission receipt is from fax machine to fax machine, not person to person. These documents stand independently from all RBs returned from the subcontractors and suppliers, which hampers a General Contractor's ability to easily recall corresponding RB history and utilize analytical software tools. Also, as stated above, PC based software-faxing tools are self-limiting and requiring continual software updates. Additionally, their respective database Contact Information may become obsolete almost as soon as it is entered; hence, many RFPs never reach the intended subcontractor or supplier and many RBs never reach the GC.

When email based systems are used, some performance improvements are achieved, but similar bottlenecks occur. Document based RFPs, or similar types of documents, are delivered to subcontractors and suppliers via an email attachment. This means that individual packets of information have to be sent across Internet Protocol (IP) lines to every intended subcontractor and supplier recipient—this is faster than faxing, but is still very inefficient and time consuming. Many of the same software companies that are responsible for marketing the aforementioned Fax systems are also responsible for creating enhancements to their static, PC based software programs. This is a slow process and can take several hours to compile and send. Again, these documents stand independently from any RBs returned from the subcontractors and suppliers, which hampers a General Contractor's ability to easily recall corresponding RB history and utilize analytical software tools without separate data entry to support the analysis. As stated above, because these emailing software tools are PC based, they require continual software updates as database Contact Information becomes obsolete almost as soon as it's entered hence; many RFPs never reach the subcontractor or supplier. Existing systems require each General Contractor to maintain their Contact Managers or contact lists independently.

Once the RFPs have been sent out, the General Contractor waits for Response Bids Via Fax. This is illustrated in FIG. 2 which shows the bottleneck that occurs when a multitude of RBs such as 34, 38 and 42 are returned to the General Contractor via fax. The General Contractor's ability to receive bids in a timely manner is in part very restricted and dependent upon the number of fax machines operating to receive the bids (generally 1-5). Additionally, a closing bid date and required return time for (RBs) often overlap, making certain RBs unusable. If one looks at the traditional 28 day letting to close time frame, faxing or email attachment systems load the front end of the time frame with sending. Then there is a gap, while subs and supplier do their “take-offs.” Then there is a dramatic and frantic spike in the job load the last day or two of the 28 day period when bids are due. This spike is generally incurred by the General Contractor, or the Government Agency responsible for the bid letting, if it is a public contract. The bid closing days themselves are often incredibly busy, and there is much room for calculating mistakes. Fax machines are by design limited to a one-way highway—you cannot send and receive simultaneously. Therefore, if a General Contractor has only one or two fax machines, but has 50 or more RBs to be returned in the final hours just before bid closing time, a severe traffic jam is created that can result in failed transmissions, lost bids and short cuts that circumvent best practices—like 50 cars merging into two lanes that all have to be at the same place, at the same time.

Since subcontractors use various software tools, document formats can vary making the subsequent process of analysis of the bids very difficult. For example, the General Contractor may receive thousands of pages of documents at fax 18 that must then be manually reviewed and analyzed to determine which subcontractors to award subcontracts. These numbers then have to be manually converted from a fax paper to a spreadsheet, or otherwise organized for analysis. Additionally, needed Pre-qualification forms and current updated insurance certificates are very rarely included because of inherent problems with faxing so much information, even though this information is often required to comply with contract terms, laws and regulations. Tracking these RBs with the General Contractor's original RFP is cumbersome. Thus, under the best of circumstances, the General Contractor often does not have all of the information needed to comply with laws and regulations and generally conform to best practices.

When an email system is used, the General Contractor waits for Response Bids via email as an email Attachment. This is certainly better than the fax approach, in terms of speed, but does not correct the underlying problems with the process and does not create and environment that encourages use of “best practices.” Bids received are still, by their nature, independent and documents that are not easily analyzed using other software tools. Pre-qualification forms and current insurance certificates are very rarely included because of the inherent problems with email and so much attached information. As with faxed bids, tracking RBs with a General Contractor's original RFP is cumbersome. Both are known as “Open Systems,” which means that the documents themselves are independent of every other process in the bidding system and both are just different mechanisms for “pushing paper.”

These problems often serve to further confound General Contractors who may know very little about the subcontractors and suppliers (“subs”) they are using, but clearly have to rely on them for materials and services. The General Contractor may not know his subcontractors and suppliers for a number of reasons, such as: 1) They are constructing a project out of their normal geographical area; 2) government M/WBE, SBE or DBE or other disadvantaged business enterprise hiring requirements often force them to deal with unfamiliar subcontractors and suppliers in order to fulfill Government demands for minority firms to get first consideration for business, or even a set percentage of the total public contract awarded; 3) their normal subcontractor or supplier firms are busy doing other work; and 4) Ownership and structure of subcontractor or supplier firms change frequently. When considered in the context of multi-million dollar projects, having the correct documentation at hand is particularly important.

Lack of this information and unfamiliarity with the subcontractors and suppliers further inhibits the General Contractor to comply with regulations and carry out “best practices”. These factors also make it difficult to assure that “good faith efforts” have been made to hire utilize disadvantaged business enterprises, and thus comply with laws regarding such matters. Additionally, structural impediments with stand-alone fax and email attachment systems, described above, will not easily allow the faxing, or emailing of several more pages of pre-qualification and insurance information—it's easier to just let it go. Therefore, the system itself creates an environment in which “Best Practice” is not practiced very often. Therefore, big financial and construction mistakes are often made at the General Contractor level because proper information has not been received on a timely basis. In the present competitive environment, General Contractors consider a 7% profit margin to be acceptable, even good. Therefore, there is little room for mistakes and/or shortcuts. With in the industry there is a joke that “it's the biggest gamble outside of Vegas.”

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 illustrates a fax based construction bidding system.

FIG. 2 also illustrates a fax based construction bidding system.

FIG. 3 is a diagram illustrating an exemplary centralized bid server network consistent with certain embodiments of the present invention.

FIG. 4 is a signal flow diagram depicting an overview of an exemplary bid process consistent with certain embodiments of the present invention.

FIG. 5 is a flow chart of operation of an exemplary main menu portion of a bid program consistent with certain embodiments of the present invention.

FIG. 6 is a flow chart depicting an exemplary bid process consistent with certain embodiments of the present invention.

FIG. 7 is a flow chart of an exemplary GC data entry process consistent with certain embodiments of the present invention.

FIG. 8 is a flow chart of an exemplary RFP submission process consistent with certain embodiments of the present invention.

FIG. 9 is a flow chart of an exemplary data entry process for a subcontractor or supplier consistent with certain embodiments of the present invention.

FIG. 10 (which is made up of FIGS. 10A and 10B) is a flow chart of an exemplary process for receipt of an RFP and an exemplary process of submission of a bid response consistent with certain embodiments of the present invention.

FIG. 11 is a flow chart of an exemplary process of receipt of bid responses consistent with certain embodiments of the present invention.

FIG. 12 is an exemplary home page of a bid system consistent with certain embodiments of the present invention.

FIG. 13, which is made up of FIGS. 13A, 13B and 13C, are exemplary administration screens or panels consistent with certain embodiments.

FIG. 14 is an exemplary screen shot of a list of subcontractors and suppliers available in a bid system consistent with certain embodiments of the present invention.

FIG. 15 is an example screen shot depicting the expansion of the administration screen selections when selection 212 is made from the main menu in a manner consistent with certain embodiments of the present invention.

FIG. 16 is an exemplary home page of a bid system illustrating a notification of an RFP in a manner consistent with certain embodiments of the present invention.

FIG. 17 is an example of a fictitious prequalification document that can be attached from the administration screen in a manner consistent with certain embodiments of the present invention as previously described.

FIG. 18 is an example of a screen shot showing all of the GCs that have included a current subcontractor or supplier in their contact manager in a manner consistent with certain embodiments of the present invention.

FIG. 19 is an exemplary screen shot of a sample report of contacts in the contact manager consistent with certain embodiments of the present invention.

FIG. 20 is an exemplary screen shot of a portion of an exemplary sample RFP data entry form used to create and submit an RFP in a manner consistent with certain embodiments of the present invention.

FIG. 21 is an illustrative screen shot showing search and selection of subcontractors and suppliers for receipt of an RFP in a manner consistent with certain embodiments of the present invention.

FIG. 22 is an exemplary screen shot of a screen used to send the completed RFP in a manner consistent with certain embodiments of the present invention.

FIG. 23 is an example of a screen shot depicting a screen for viewing, printing or storing a copy of the RFP in a manner consistent with certain embodiments of the present invention.

FIG. 24 is an example screen shot of an RFP and bid summary page consistent with certain embodiments of the present invention.

FIG. 25 is an example screen shot showing details of a received bid consistent with certain embodiments of the present invention.

FIG. 26 is an example screen shot showing private RFP notifications in a manner consistent with certain embodiments of the present invention.

FIG. 27 is an example screen shot of an RFP history screen consistent with certain embodiments of the present invention.

FIG. 28 is an example of a screen shot depicting a M/WBE, DBE (or other disadvantaged business enterprise) report consistent with certain embodiments of the present invention.

FIG. 29, which is made up of FIGS. 29A and 29B, are example spreadsheet views of private bids consistent with certain embodiments of the present invention.

FIG. 30 is an exemplary bid response form consistent with certain embodiments of the present invention.

FIG. 31 is an illustrative screen shot showing a digital signature card associated with a particular bid in a manner consistent with certain embodiments of the present invention.

FIG. 32 is an illustrative screen shot of a bid history for a subcontractor or supplier consistent with certain embodiments of the present invention.

FIG. 33 is an example spreadsheet view of a bid history consistent with certain embodiments of the present invention.

FIG. 34 is an example of a bid history management report consistent with certain embodiments of the present invention.

FIG. 35 is an illustrative flow chart of one business model for use of the present bid system consistent with certain embodiments of the present invention.

FIG. 36 is an illustrative flow chart of certain operations of a government entity interaction in a bid system consistent with certain embodiments of the present inventions.

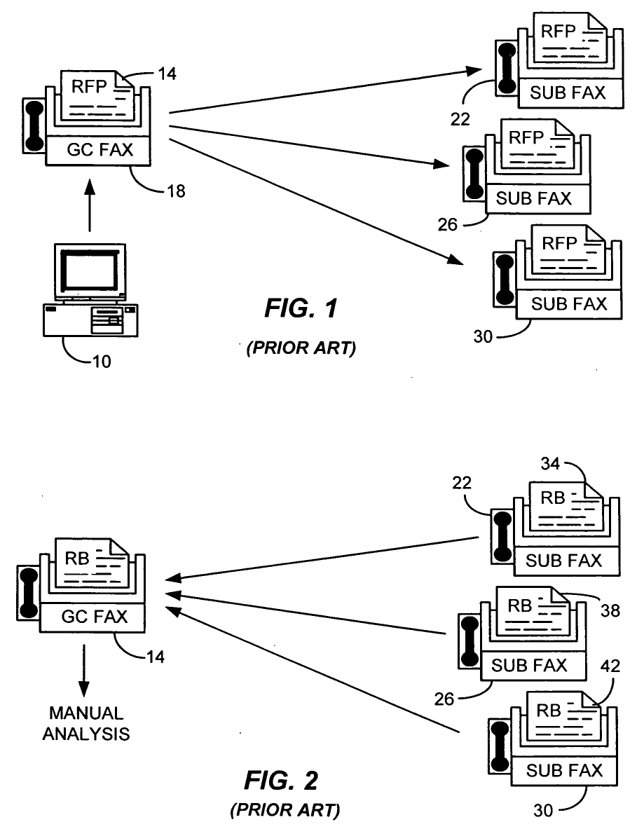

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system. The terms “instantly”, “instantaneously” and similar terms mean “quickly”.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

As used herein, the term “commercial construction” is used in connection with construction of commercial projects such as office, retail or apartment buildings, highways, bridges or other large construction projects whether funded privately or publicly (i.e., a government contract can be considered commercial construction under this definition). The term “residential construction” is used to mean smaller projects such as single family or small multiple family dwellings and apartments. While certain embodiments consistent with the present invention are particularly useful for large commercial construction projects, smaller residential construction projects are not precluded.

Also for purposes of this document, the term “supplier” and “subcontractor” can often be considered synonymous since each can be an entity that responds to a request for proposal with a bid response. In the case of a supplier, a bid response may simply involve responding with material quotes, while a subcontractor may respond with material quotes as well as labor and other quotes. It should also be noted, that on large commercial jobs, a subcontractor may further contract with suppliers and subcontractors. Thus, a subcontractor may also often operate as a general contractor. These terms, as well as the term “sub” are used interchangeably without limitation to mean either or both. The terms “panel”, “terminal”, “screen”, “page” and similar terms are used somewhat interchangeably within the present document to refer to a web page or screen image present at a particular phase of processing.

Further, in the current document, an example of W/MBE (Women/Minority Business Enterprise) is often used. However, different entities may be interested in different types of Disadvantaged Business Enterprises (DBE), Historically Underutilized Businesses, Small Business Enterprises (SBE) or other disadvantaged businesses. For purposes of this document, such disadvantaged groups are referred to interchangeably without limitation. Thus, where one such entity is referred to as an example, the reader should understand that the term is intended to encompass any one, a plurality of, or all types of disadvantaged businesses.

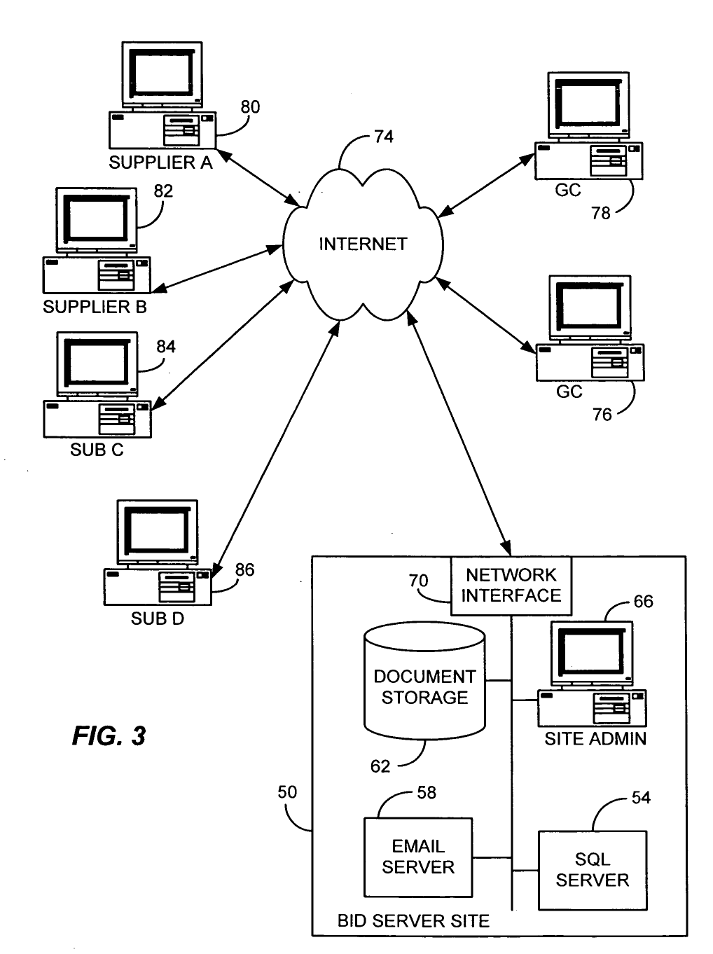

Referring now to FIG. 3, an electronic network arrangement suitable for use in conjunction with certain embodiments consistent with the present invention is illustrated. In this embodiment, a bid server arrangement 50 is situated at a bid server site and utilizes an arrangement of networked computers to facilitate the transactions associated with embodiments of the current construction bid process. In this example embodiment, a database server (Microsoft SQL Server, but Oracle or other robust database software can be used as well) 54 is networked with an email server 58 and a document storage server 62. All operate in concert under direction of the site administrator computer 66 via a local network connection 70, e.g., an Ethernet network or token ring network. In certain embodiments, the site administrator computer may operate as a control processor using any suitable programming languages. In the present embodiment, Macromedia Cold Fusion MX™ is used along with HTML, JavaScript, ASP, and other appropriate languages as needed. In this area there are multiple configurations to meet specific needs, skill-sets and preferences. The database server 54 uses Microsoft SQL Server 2000™. The document server can be equipped with RAID (Redundant Array of Independent Drives) disk drives. Additionally, it is preferred that the server or servers of the present system physically reside in an appropriate physically secure location, for example a present embodiment resides two stories above the USLec telephone switch for a whole variety of speed and security issues, with multiple configurations of battery backups, and indefinite generator back-up. Of course, this should not be considered limiting.

In this example, document files such as RFPs, RBs, Insurance Certificates, and other such files are stored on document storage 62. A database of subscribers—contractors, subcontractors and suppliers—is maintained on SQL server 54. Email is generated and managed on server 58. While multiple servers operate in concert to accomplish the functionality described herein, other server arrangements or even a single server can also possibly carry out this functionality. Collectively and individually, these servers may be referred to herein as server 50.

The bid server 50 also incorporates a network interface 70 (which may include gateway and firewall functionality) through which the server 50 connects to the Internet 74 in order to be readily and securely accessed by multiple general contractors such as 76-78, as well as multiple suppliers 80-82 and subcontractors 84-86, who can log on to the server using known secure protocols. It is noted as described above that general contractors may, in some instances behave as subcontractors and vice versa. The interaction of these various players will be described in greater detail as this discussion proceeds.

Before proceeding, it is useful to examine the needs of a general contractor (or other contractor) in order to operate in an environment where “best practices” are followed. The existing bidding systems generally do not take these needs into account and as a result, many practices considered by the industry to be “best practices” are not followed. Ideally, the contractor should be able to send out RFPs quickly and inexpensively and receive pre-qualification information Structure/Personnel/References/Financials/Safety Information) on every subcontractor/supplier with every Response Bid (RB), or on-demand, as needed. The contractors should also receive current Insurance Certificates with every RB. Moreover, quick transfer and tracking ability of RFPs and RBs should be possible along with W/MBE (Women/Minority Business Enterprise) reporting and other reporting capabilities. Finally, an ability to efficiently apply software tools to examine and sort through multiple RBs to identify potential subcontractors and suppliers should be provided.

In accordance with certain embodiments, the present construction bidding system (Bidrunner™ trademark of Virtual Design Network) provides a mechanism for operating in accordance with such best practices. Bidrunner™, (Bidrunner) in the exemplary embodiment described herein, is an exemplary web-based software application designed to radically increase the speed and ease of document transfer, specific to RFPs (Request for Proposals) and RBs (Response Bids), between construction general contractors, subcontractors, and suppliers; and to create an infrastructure in which “best practices” can be exercised throughout these information transfers. Specifically, RFP and RB notifications are provided near instantaneously. Secondary functions, which have traditionally taken a great deal of time to manage by GCs, Subs, and suppliers, can now be done quickly because of substantial business methodology changes:
1. Financial/Business Pre-qualifications track with every Response Bid from subcontractor or supplier. When these are updated by subcontractor or supplier, they are instantly updated for GC.
2. Bid-Day Terminal compiles RFP and corresponding Response Bids as they are sent to GC. There is no fax jam and no dependence on Email Servers that are expected to process emails with large attachments.
3. Real-time spreadsheets (e.g., HTML or Microsoft Excel™ format spreadsheets) can be near instantaneously generated on all RFP and RB submissions.
4. Subcontractor or supplier can instantly indicate whether or not they intend to bid on project—and this information is transferred to GC.
5. GC can instantly accept a bid from a subcontractor or supplier—and this information is near instantly transferred to all parties.
6. Contact Managers are near instantly updated across the system for all parties when changes are made by any GC, Sub, or supplier.
7. M/WBE (Minority/Women Business Enterprise) or other Disadvantaged business enterprise reports can be quickly and easily generated and sent to government agencies responsible for assisting minority clients in obtaining contracts.
8. All document transfers can be viewed/printed/saved by GC, Sub, or supplier on their time schedule, not the fax machines.
9. Government agencies, such as State and Federal DOT (Department of Transportation, and HUB (Historically Underutilized Businesses) can post Public Lettings to “Prime Contractors” and/or minority firms. This means that those firms do not have to search other data sources in order to stumble across business opportunities. Most importantly, because of the current exemplary “Closed System” approach to RFP and Bid transfer and compiling, government agencies can get statistical data they have never been able to get. For example, using certain embodiments consistent with the present invention, these agencies can now look at individual Minority firms, view how many RFPs have been sent to them and how they have responded to them. Also, agencies can monitor “Migration,” which is the movement of Minority firms from M/WBE and DBE lists provided by the states unto private General Contractors normal RFP sending lists.

The Bidrunner™ web based bid system implements one embodiment consistent with the present invention which will be described as an illustrative but non-limiting embodiment. This system creates private, virtual communication tunnels between General Contractors, subcontractors and suppliers, through which RFPs and RBs can be viewed, printed, and saved in a seamless, easy to use and traceable manner. Response Bids (RBs) from subcontractors and suppliers are then compiled with digitized pre-qualification information and insurance certificates, which track with the RB and become part of a package of information that better achieves a “best practices” model and allows the General Contractor to make better final bid decisions quickly and easily.

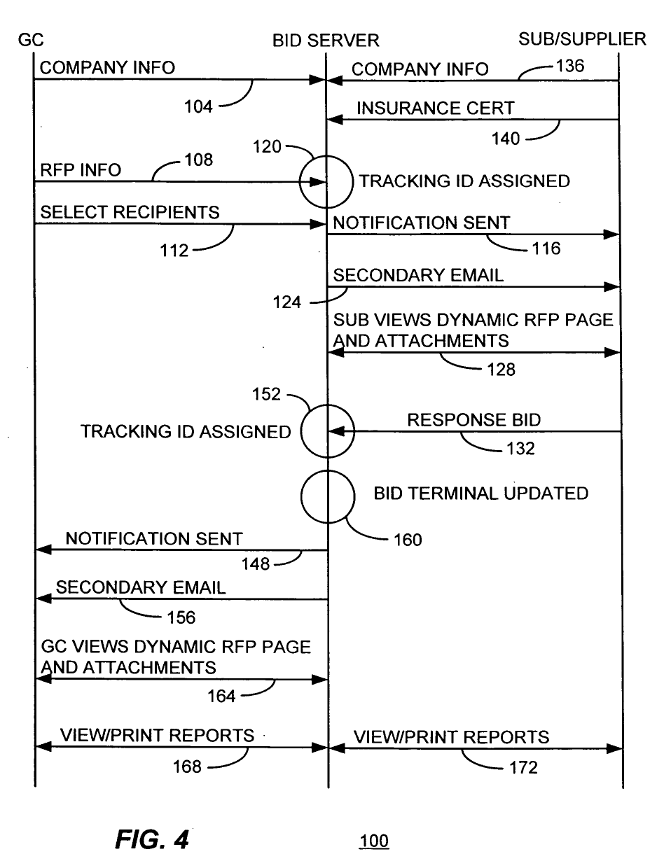

The following is an outline of one overall process used in accordance with certain embodiments, which will be explained in greater detail later. This process is also depicted (with less detail) as an overview in the signal flow diagram 100 of FIG. 4.

Sending RFPs:

The GC enters the Administration Screen. At this screen company information can be entered once at 104, and this information will then track with all correspondence. The information can be edited or updated at any time. The GC can also upload a company logo and company photo and can provide a company description.

The GC enters general tracking data on a specific RFP, i.e., RFP number, location, close dates/times, needed CSI codes. RFP planning room link, etc. A word processing document (e.g., or Microsoft Word™ document), spreadsheets such as Microsoft Excel™, or Adobe PDF file, or any multiple combinations of these can then be uploaded for the specific RFP. This process is depicted by arrow 108. The GC then digitally signs the compilation.

The Contact Manager module can then be queried at 112 to identify suitable subscribing recipients and the GC chooses RFP recipients. The General Contractor's Contact Manager in the bid system can be queried by State, Company Name, Company City, General CSI (Construction Specifications Institute) Division, CSI codes, NAICS (North American Industry Classification System) codes, Geographic Area which subcontractor does business, or multiples of any or all of these at one time, which are required for completion of the project, i.e., those that should get the RFP. In this embodiment, there is also a “Favorites” quick click button, which immediately loads pre-selected contacts. The GC can then remove any unwanted contacts, then click a submit button to submit the RFP. When the Submit button is clicked, the text data information is uploaded into the SQL Server database and the documents are transferred to a temporary folder, given a seven digit random code and stored in the appropriate folder structure within a separate server. Hundreds of RFP notifications can then be sent nearly instantly at 116. A unique web page link is generated which houses all GC and specific RFP information which can then be Viewed, Printed or Saved by the recipients as desired. The subscribing recipients than receive a “Notification Light” (a blinking light or other visual indicator) and a web page link in their Administration Panel (that can be viewed whenever the user is logged in) that indicates that they have received a specific RFP from a specific GC.

The RFP document is given a specific tracking marker I.D. at 120, which links with GC I.D., as well as, tracks with recipient subcontractor or supplier I.D. A secondary, non-attachment email is sent at 124 notifying the subscribing subcontractor or supplier that a specific RFP has been sent to them from a specific GC. This email links to dynamically produced RFP output web page, which houses all RFP information that can be Viewed/Printed/Saved at the subscribing subcontractor or supplier's leisure. Through the link on their Administration Panel, or on the email, the recipient can open a web page (that was dynamically created automatically when the RFP was sent) that gives details on the RFP, such as name, number, location, CSI codes needed, closing date and time—this info is pulled from the database. At this point, the bid document (e.g., a Microsoft Word™ format document, Excel™, or PDF) has been moved once, into a file—unlike the fax, or email attachment in which it has to move dozens of times regardless of supplier interest. At this time, both the General Contractor and the supplier have a track-able document transfer that can be called up from their Administration Panels and used in reporting systems.

Receiving RFPs:

The subcontractor or supplier enters the Administration Panel and sees an “RFP Notification Light.” They can view the RFP which is in the form of a dynamically created web page at 128 and indicate whether, or not they intend to bid on this RFP—this information is immediately made available to GC. The GC's company data populates the dynamically produced web page that is sent to subscribing subcontractor or supplier. This includes links to GC's contact info, personal website, email links, and specifics regarding RFP number, location, needed CSI codes for RFP, Planning Room links for specific RFP, links to the detailed RFP document and to a digital signature card.

The RFP document file is linked and tracked with unique marker I.D. for the specific RFP and the link appears on web page. This document can be viewed, printed or saved at any time by recipient subcontractor or supplier. The digital signature card, which can also be viewed, printed or saved, is available to attach to. RFP document by subcontractor or supplier. The company logo and photo also appears on the RFP output web page.

Subcontractor or supplier receives the secondary (fall-back) non-attachment email 124 that gives overview about specific RFP; with link to dynamically produced RFP output web page. This provides a secondary mechanism for notification when the subcontractor or supplier is not logged in. They can indicate from this email whether, or not they intend to bid on this project—this information is immediately made available to GC.

The RFP Result:

The subcontractor or supplier is near instantly notified of an RFP sent to them by a GC. No fax machines and no email attachments are required. They can view, print or save any aspect of this RFP on their time schedule. Response bids can be compiled with this RFP into meaningful reports (discussed later). When a response bid is generated by subcontractor or supplier, all general RFP information is pre-populated on a Bid Response form. Subcontractor or supplier is assured that Response Bid is going to the right person, privately when the RB is sent at 132. Additionally, a General Contractor can view all of the RFP recipients. These recipients can nearly instantly notify the contractor if they intend to bid. (This is currently a big problem for General Contractors, who many times go into the closing hours of bid-day not knowing who is bidding on a particular project.) Also, a change in the RFP can be sent, for example, in the form of a word processing, spreadsheet, image file, or PDF file by uploading it into the system like the original RFP, but instead of querying contacts again, these documents are sent to the original recipients automatically. All of the above can be instantly converted to an Excel spreadsheet.

Sending a Response Bid:

If the supplier wishes to respond with a bid to a GC's RFP, they simply click a button entitled “Respond With a Bid” or similar designation. This also can be a word processing document, spreadsheet, image file, PDF file, or any combination. This opens a new browser window that pre-populates the basic RFP information, such as recipients name, email, RFP name, number, location, CSI codes, closing date and time, etc.

The Subscribing subcontractor or supplier has probably already entered the Administration Screen, in which to enter company and extensive Pre-qualification information at 136, (only required once), which tracks with all correspondences. This information can be edited or updated at any time. This information can include contact information, company structure, minority status information, bond and financial information, personnel and reference info, health and safety info. Any fields left blank are populated with “Not Specified,” which gives subcontractor or supplier control over what information is shared. This is not public information, but tracks with specific Response Bids on specific RFP sent to them by GCs. They upload scanned Insurance Certificates, if one is available, at 140. They can also upload a company logo and company photo, and they can add a company description.

Note: The supplier or subcontractor will have previously filled out Pre-qualification information into the bid system, which is stored in the database in a text-delimited format. This covers, for example, company structure, minority business status, bonding info, personnel, financials, references, safety and drug program information.

The Subscribing subcontractor or supplier clicks the “Send Response Bid” button at 132 for a specific RFP that has been sent to them. The Bid form pre-populates all given RFP information, such as GC recipient. RFP number, location, closing date/time, etc. He/She then uploads a Response Bid document at 144 for the specific RFP and digitally signs compilation. A notification of this RB is then sent to the GC at 148.

The RB document is given a specific tracking marker I.D, different than the original RFP document I.D. at 152, which links with the GC I.D. and the RFP I.D., and tracks with recipient subcontractor or supplier I.D. In this embodiment, there are now four separate seven digit random numbers that identify the compilation of this transaction (of course, other specifics regarding the assignment of ID numbers are also possible within the scope of the present invention.

A secondary, non-attachment email is also sent at 156 notifying the GC that a specific Response Bid has been sent to them from a specific subcontractor or supplier. This email links to dynamically produced Response Bid output web page, which houses all Response Bid information that can be Viewed/Printed/Saved at GC's leisure.

The Administration Panel and the email notification have a link to a dynamic web page specific to the particular subcontractor or supplier. This web page has a link to “call-up” the Response Bid document, tracked with the original RFP. If the General Contractor wishes to “call-up” the document, then they can view/print/save the document. On this web page, the General Contractor, can view/print/save all aspects of the Response bid document, the pre-qualification information on the supplier, the current Insurance Certificate, the Digital Signature Card, along with a vast amount of Contact Information, email links, website links, etc. Now, in both the General Contractor's and supplier's Admin Panels is the ability to “call-up,” these documents at will. Also, these documents can be tracked by looking at RFP and Response Bid history.

At any time, but particularly on bid-day, the GC use a “Bid Day Terminal” can call-up a specific RFP and literally watch Response Bids enter their Administration Panel in real-time. The bid day terminal is updated at 160 at periodic intervals (e.g., every several minutes) so that the terminal always shows a latest set of RBs. Any aspect of the original RFP and all Response Bids can be viewed, Printed or Saved at any time at 164. These Response Bids also include all contact info and pre-qualification info, which can also be viewed, printed or saved at any time.

The subcontractor or supplier company data populates the dynamically produced web page accessible by GC. This includes links to subcontractor or supplier contact info, personal website, email links, and specifics regarding RFP/Response Bid number, location, their particular CSI code expertise, several web pages of pre-qualification information (which can be converted to an RTF document and printed and filed, if appropriate), and links to detailed response bid, to digital signature and to insurance certificates.

The RB document is provided via a link on the web page and is tracked with unique marker I.D. generated at 152 for the specific RFP/Response Bid that appears on web page. This Response Bid document can be viewed, printed or saved at any convenient time by recipient GC. The digital signature card, which can also be viewed, printed or saved, is also available to attach to the Response Bid document by the GC. A link to view, print or save the Insurance Certificate is also made available if one has been uploaded. The company logo and photo of the subcontractor or supplier appear on RFP output web page.

The GC receives a secondary/fall-back non-attachment email at 156 which gives an overview about the specific Response Bid, with links to dynamically produced Response Bid output web page.

At this point, every aspect of the RFP, Response Bid, and all ancillary information has been compiled and are track-able. The GC is instantly notified of a Response Bid sent to them by a subcontractor or supplier. No fax machines and no email attachments. They can view, print or save any aspect of this Response Bid on their time schedule. Response bids are compiled with this RFP into meaningful reports at 168 and 172. The GC can indicate immediately whether a subcontractor or supplier has been awarded the contract and this information is instantly made available to subcontractor or supplier in their Administration Panel.

At any time a GC can look at their RFP history and compile Response Bids from subcontractors and suppliers at 168. They can quickly generate HTML or Excel™ format spreadsheets, which tell whom the RFP was sent to, whom intended to bid, all of the Response Bid information. Additionally the GC can generate this report into an M/WBE report that can be sent to interested public agencies in seconds. Also, because of the exemplary Bidrunner™ system structure, all contact managers are kept current. Any time a subcontractor or supplier changes any aspect of their contact information; it is instantly changed in the GC's contact manager.

At any time a subcontractors or suppliers can look at their received RFP history and compiled Response Bids at 172. They can quickly send word processing, spreadsheet, image or pdf addendums, or withdrawals from their original bid. They can quickly generate HTML or Excel™ format spreadsheets, which give them information on all aspects of their Response Bids. Additionally, a subcontractor or supplier can instantly generate and send a Bid Report to company managers who wish to track this Response Bid history.

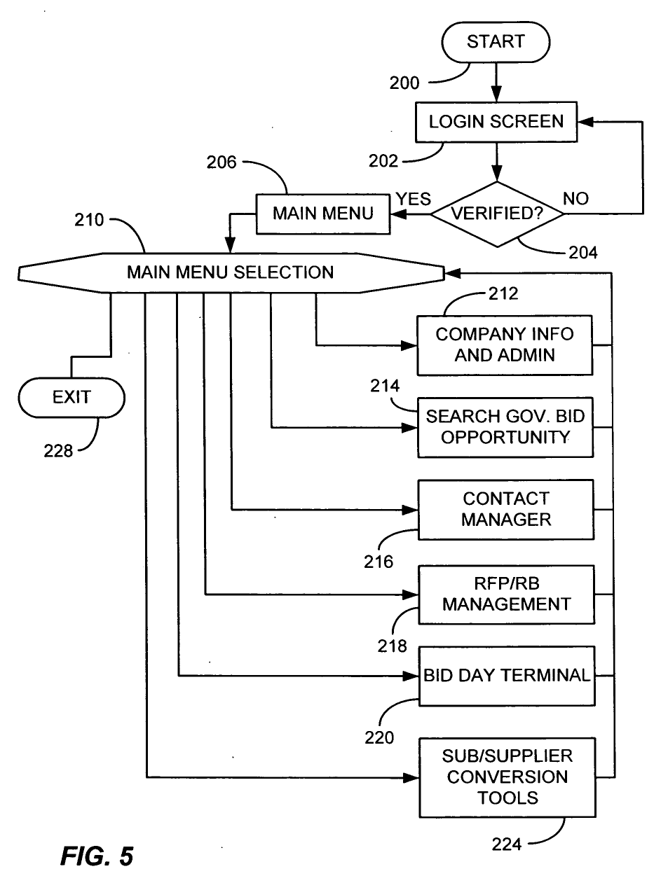

Turning now to FIG. 5, a flow chart depicts operation of certain elements of a home page or main menu system of a bid system consistent with certain embodiments starting at 200 where a user navigates to the address of server 50. at 202, the user is presented with a login screen where a login procedure is carried out with a user name and password. If the user's access privileges are verified at 204, the user is presented with a home page or main menu at 206 which provides multiple selections from which the user can choose at 210. Among those selections in certain preferred embodiments are a “company information and administration” selection 212, a search government bid opportunity selection 214, a contact manager selection 216, an RFP/RB management selection 218, a bid day terminal selection 220, a subcontractor/supplier conversion tool selection 224 and an exit selection 228 to terminate the session.

This home page menu provides a launch pad for GCs, subcontractors, and suppliers to utilize the bid system to carry out the bidding process in the manner outlined above. In the bid and response processes, pages 212, 216, 218 and 220 are utilized in the manner indicated in the following flow charts which follow the bid and response processes.

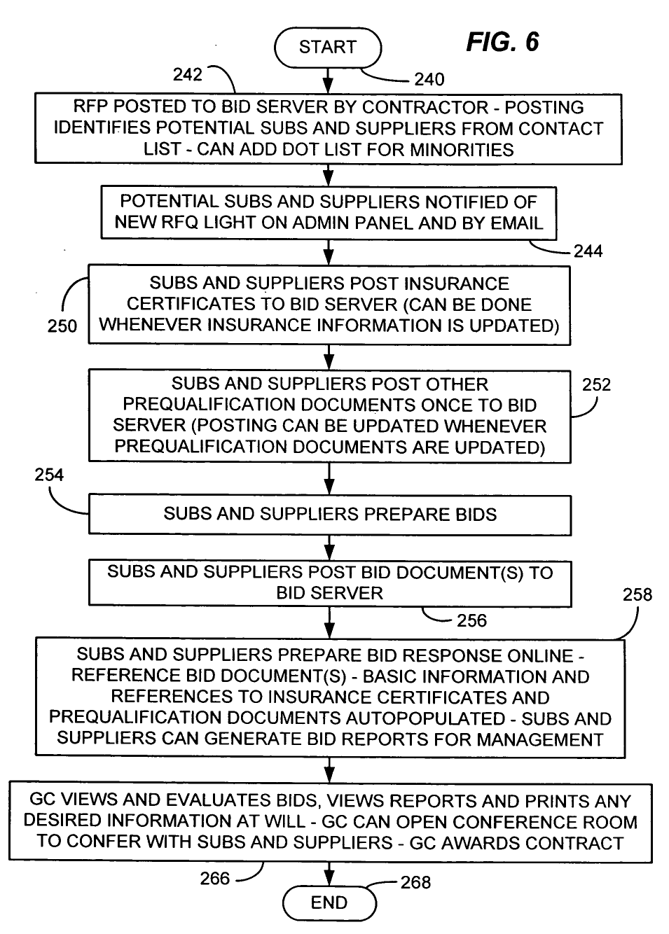

With reference to FIG. 6, the bid and response process is again briefly summarized, this time in flow chart form starting at 240. Generally speaking, the chronology of this chart, and other flow charts herein, is not rigid since many functions can take place at any time and in many possible sequences. At 242, an RFP is posted to the bid server 50 by a contractor acting as a General Contractor. The posting identifies potential subcontractors and suppliers that are taken from a contact list provided by the contact manager module. In certain embodiments consistent with the present invention, a significant advantage is provided to State DOTs (Department of Transportation) or other government agencies in that the General Contractor can near instantly add contractors from a Department of Transportation list for minority or other disadvantaged subcontractors and suppliers. These lists can be supplied by the individual State DOTs or other government agencies and are kept current by them and supplied to Bidrunner on a predetermined time schedule. At 244 the selected potential subcontractors and suppliers are notified by a flashing light in their administration panel as well as a secondary email of the new RFP. The subcontractors and suppliers are able to post insurance certificates to the bid server 50 and this information can be updated at any time at 250. Subcontractors and suppliers can also post other prequalification documents such as financial information and other information at any time at 252. This need only be done once but can be updated at any time.

The subcontractors and suppliers then review the RFP prepare bid responses at 254. The responses generally might include a number of documents created by word processing and/or spreadsheets or other computer programs that can then be posted to the server 50 at 256 by uploading files to the server 50. The bid responses can then be prepared at 258 online and reference the bid documents that are uploaded. The bid responses will automatically link to the subcontractor's or supplier's basic company information, prequalification information and insurance information. The bid response is automatically populated with common data relating to the subcontractor or supplier. The subcontractors and suppliers can generate and send reports to management from this tool as well.

At 266, the General Contractor is able to view and evaluate the bids, generate and review reports and print any desired information at will. The system generates comparative reports that lend themselves to easy analysis since all information for all bids is assembled into spreadsheet format that can be sorted as desired for easy comparison of competing bid responses. Additionally, the GC can open a “Conference Room” communication channel with any selected subcontractor or supplier to resolve any matters that are not clear from the bid. This process resembles an instant messenger or private email function between the two parties and advantageously can be printed out to document agreements or understandings reached via the conference. This feature of certain embodiments can often be useful to General Contractors, because these “Conference Room” discussions are time and date stamped and can eliminate potential misunderstandings on the scope of the project and circumvent potential lawsuits. These “Conference Room” compile all (4) 7digit Sub, GC, RFP, RB for reference, security and process. The GC can then make a selection of a winning bid in an efficient manner and the process ends at 268.

When a user (contractor, subcontractor or supplier) logs onto the secure server system 50, an administration screen can be entered to manage RFPs and RBs. A contact manager module is provided in which the user can update information about his own company (contact information, logos, photographs, and other biographical information) and in which a user can view contact information regarding other companies. The contact manager interacts with the administration screen (panel) to permit the user, whether GC, sub or supplier, to enter data relevant to his company. This information can then be used by the system to simplify assembly of bids and responses that are processed later. Absent a bid, this information can generate a page that can be used by subcontractors and suppliers to introduce themselves to new General Contractors, i.e., to show what they've done in the past and what they're capable of doing for the GC.

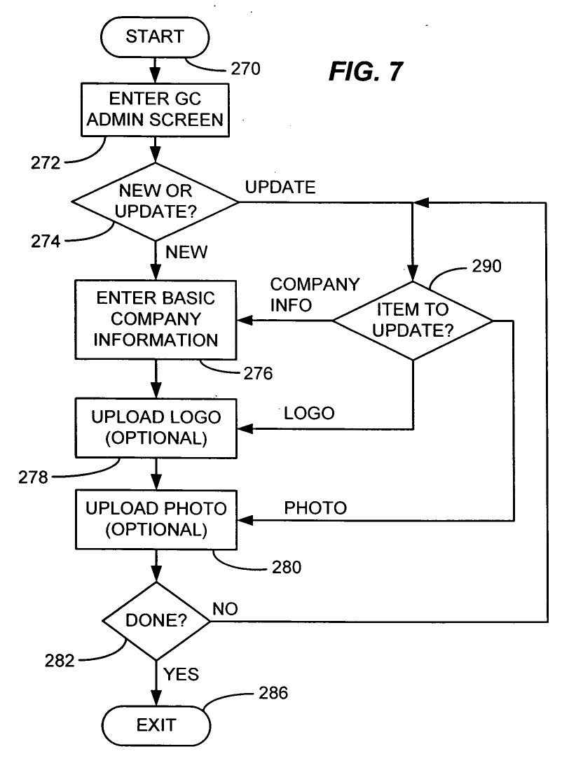

Consider the flow chart of FIG. 7, which depicts a basic process used by a GC to input or update company information, starting at 270. The GC enters the GC administration screen at 272. By navigating the menu selections available on this screen, the user is able to enter new company data (for a new subscriber) or update that information when it changes for whatever reason. If new data are to be entered at 274, the basic company information (name, address, other contact information and general corporate description data) is entered by either keying in the data or making appropriate choices from menu selections (e.g., to select a category of services) at 276. The GC can also optionally upload a logo at 278 or a photograph of personnel, facilities, etc. at 280. Once this basic information is entered, it can be corrected or updated at any time. When the initial data entry is completed at 282, to administration screen or the bid system can be exited at 286.

If any item of data changes, the GC can log in and return to the administration panel at any time and update the basic information at 274 by simply selecting the item to update at 290 and making any necessary edits or uploads. As previously noted, the data as entered or uploaded are then available to the bid system to assemble along with any specific bids posted by the GC.

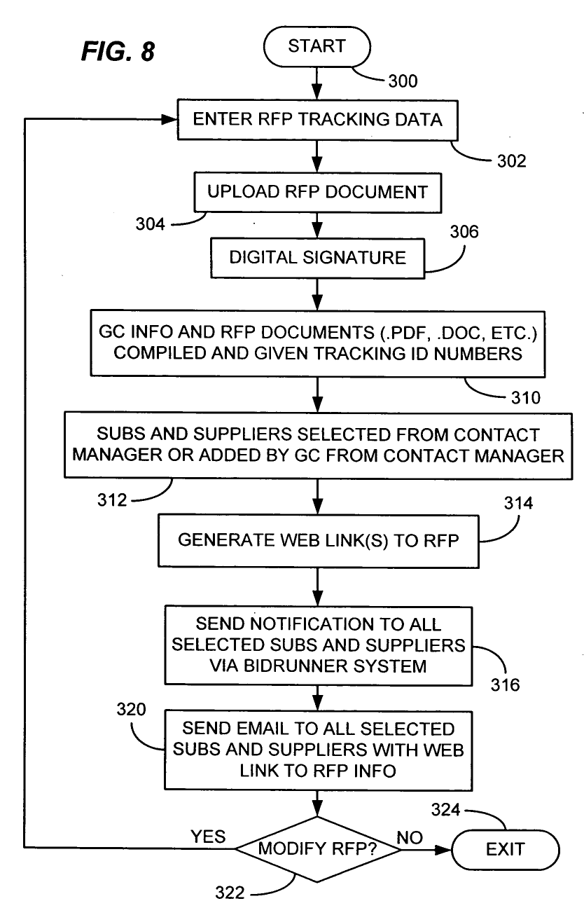

Now consider the process used by the GC to enter a particular RFP as depicted in FIG. 8, starting at 300. This process is initiated from the RFP/RB management menu of FIG. 5 and starts with entry of tracking data for a particular RFP at 302. Such tracking data might include a title, RFP number and other identifying information. The GC then uploads a document (e.g. a word processing document or document in any other suitable format, such as an Excel™ or PDF formatted document) that describes the details of the RFP at 304. This upload and tracking data are then digitally signed to assure authenticity at 306.

At this point, the bid system compiles the GC information entered in FIG. 7 with the uploaded RFP and the RFP tracking data at 310 and the compilation is assigned an identification number (or other unique identifier) that is automatically and uniquely generated by the bid system. Potential subcontractors and suppliers are selected by the GC from the contact manager or added by the GC from a personal contact manager at 312. The bid system then generates web links to the RFP at 314 and sends notifications to all of the selected potential subcontractors and suppliers identified at 312. Notification is via the bid system at 316 in addition to a secondary email notification for subscribers at 318. The email notification contains a web link to the RFP that can be used to access the information if the subcontractor or supplier is not logged in to the bid system.

In this manner, the GC is able to efficiently send the RFP in it's entirety to multiple subcontractors and suppliers without need for a massive mailing or faxing operation. In the event a modification is needed to the RFP at 322, an addendum or correction can be made by returning to 302 and repeating the process with a link to the original RFP. The process is completed at 324. While not explicitly shown in this chart, other links can also be provided that can be useful to the subcontractors and suppliers. For example, the GC may wish to provide a link to a virtual “design/planning room” which provides access to details of a particular design associated with the RFP. Many variations will occur to those skilled in the art upon consideration of the present teachings. Architects are using PDF documents more and more, which include design elements, plans, and provide security—these can be uploaded in the original RFP, without the need for a “design/planning room” link. In essence, certain embodiments consistent with the current invention can avoid movement of the same documents over and over.

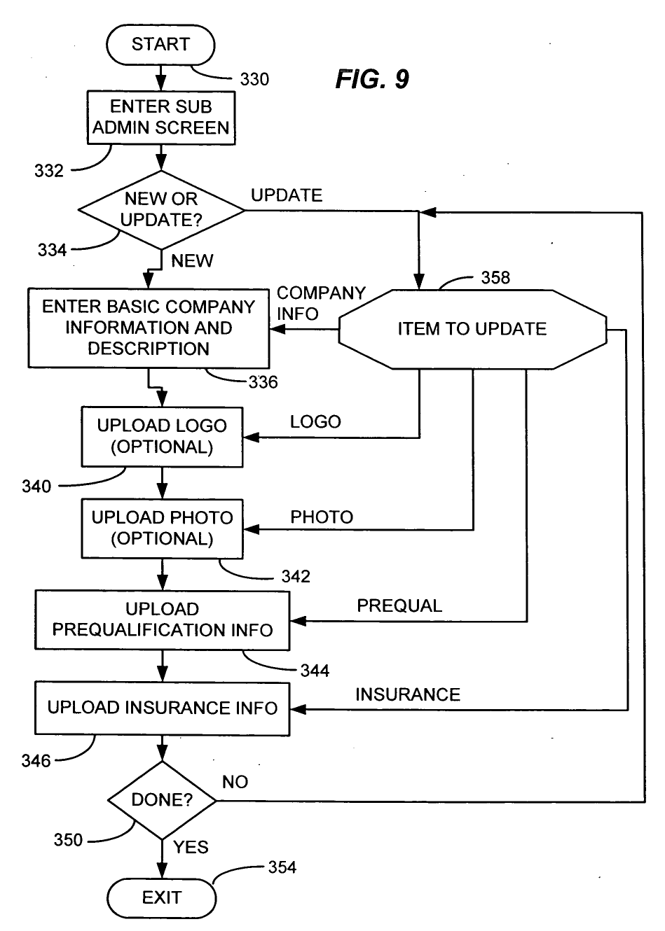

Turning now to FIG. 9, a process for entering basic company information into the bid system for use by subcontractors and suppliers is depicted starting at 300. The subcontractor or supplier logs in and enters the administration screen 212. If the company is a new subscriber to the bid system at 334, the user enters basic company information and descriptive information at 336. The user can then upload a logo, photo, prequalification information and insurance certificates at 340, 342, 344 and 346 respectively. If the user is completed at this time at 350, he/she can exit the admin screen or the system at 354. Or, upon review of the entered information can make corrections by passing to 358 from either 334 or 350 and reentering or uploading as required to update the information. Many variations on this process will occur to those skilled in the art upon consideration of this teaching. Once this information is completed, it is available to general contractors via the contact manager.

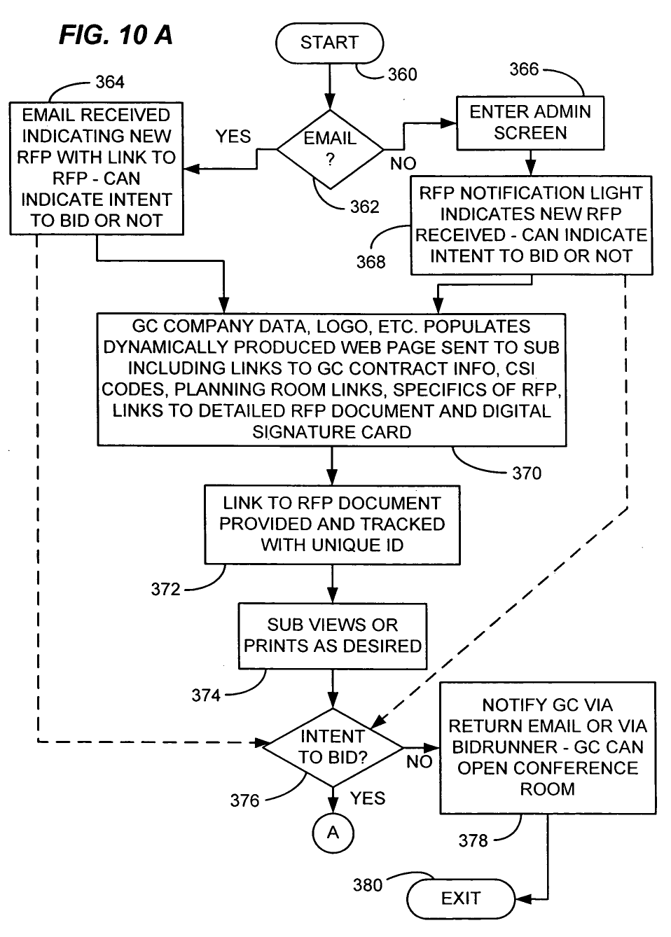

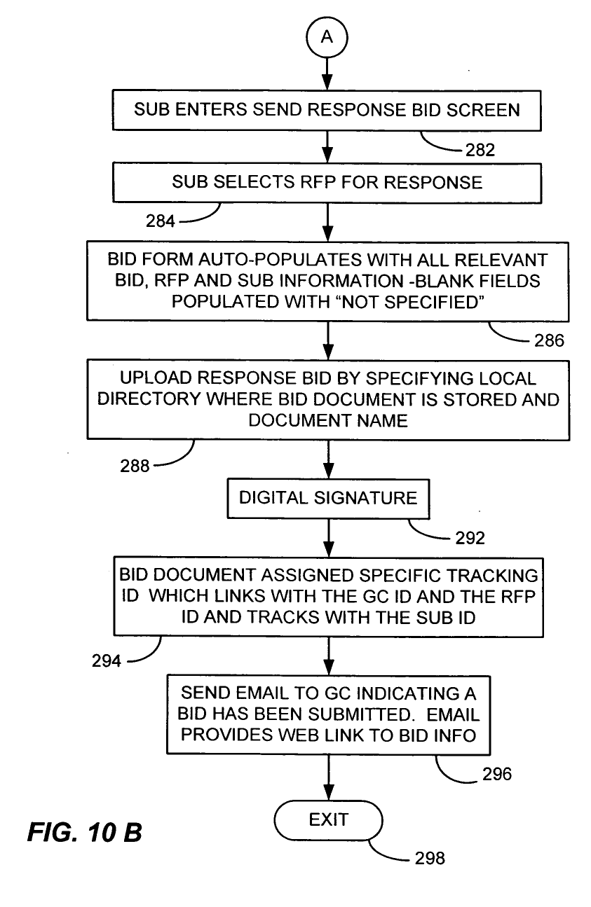

Once a subscriber is registered as a subcontractor or supplier and the company data are stored in the contact manager, the company may be selected as a potential supplier or subcontractor and may begin receiving bids for jobs which the company appears qualified to perform. An exemplary process for receipt of RFPs via the present bid system is depicted in the flow chart of FIG. 10 (which is made up of FIGS. 10A and 10B). In this process, starting at 362, the user can be notified of receipt of an RFP by either of two mechanisms—namely email or via direct communication through the bid system. If an email is received indicating a new RFP at 362, the user can use a link in the email to reach the RFP at 364, where the user can also indicate an intent to bid or not. The user can also respond directly to the email to indicate an intent not to bid, if he/she so chooses. The user can also be notified of an RFP via logging in to the bid system, entering the administration screen at 366 and observing a light on the administration panel at 368 indicating receipt of a new RFP. The user can respond directly with an intent to bid or not at this point too if he/she so desires.

In either case, the system generates a dynamically produced web page that is populated with the GC company data, logo, photo, etc. and providing links to the GC contract info, CSI codes, planning room links, specifics of the RFP, links to the RFP document and a digital signature card at 370. This link is provided using a unique tracking number as indicated by 372. This web page is made available to the user to view or print as desired.

The subcontractor or supplier can then review the RFP in its entirety if desired and can determine whether or not he/she wishes to bid. If desired at 376, the user can send an indication of intent to bid or not to the General Contractor at 378 and the process ends at 380. If the GC desires, a conference room can be opened at 378 to confer. Again, this conference room produces a printable record of the conference as previously described.

In the event the subcontractor or supplier intends to bid on the job at 376, a bid can be prepared and submitted according to the process described in connection with FIG. 10 B. In order to respond to the RFP, the subcontractor or supplier enters the “Send Response Bid” screen at 282 from the RFP/RB management menu 216. An RFP is then selected from a list of possible RFPs for a response at 284. This causes the bid system to autopopulate a bid response form with all of the relevant bid information along with all of the subcontractor or supplier's identifying information and links to the subcontractor or supplier's insurance and prequalification information. Any information not supplied by the subcontractor or supplier is marked as “not specified” by default. The information supplied by the subcontractor or supplier at this point includes summarizing information regarding the bid response (e.g., bottom line price and other information). The subcontractor or supplier prepares a document detailing his response to the RFP and uploads this document at 288 and provides a digital signature at 292. This bid response is then assigned a unique tracking ID number by the bid system that links with the GC's ID and the RFP ID and further tracks with the subcontractor or supplier ID. The GC is then notified at 296 via the administration panel light and via a secondary email that a response has been received. On bid closing day, the GC can also watch the bid terminal to observe last minute bids being submitted as will be described later. The subcontractor or supplier can add an addendum to correct information or supply additional information at any time using the same process and associating the new information with the existing bid response and RFP. The process ends at 298.

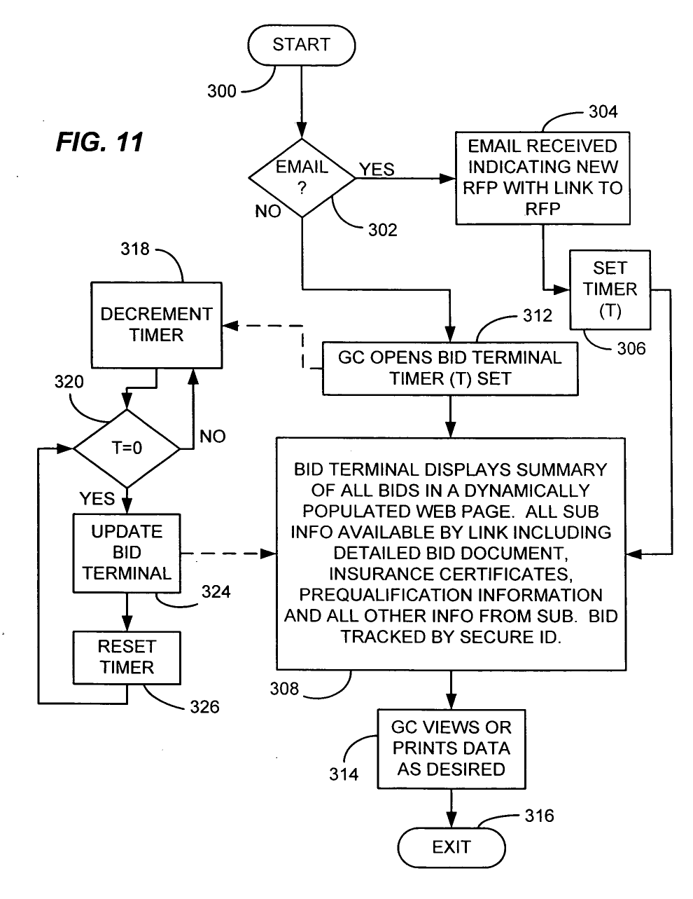

At any time, but especially on the final day of acceptance of bid responses, the GC can open the bid day terminal 220 from the main menu to see a nearly live view of the bidding activity. The bid day terminal acts to summarize the received bid responses in a tabular or spreadsheet like format that is conducive to a quick analysis of who has responded to the RFP and what the “bottom line” price is. Other information is or can be displayed too, including minority business status and other useful information to give the GC an overview of the bid status. The operation of the bid day terminal is described in connection with FIG. 11 starting at 300. As is the case for many notifications used in the present system, the user can enter the bid day terminal by virtue of either being notified by email or by directly entering the bid day terminal from the main menu to directly view the activity. If an email is received at 302, which indicates at 304 that a new RFP has been received, the GC can simply use the link provided in the email to link to the bid day terminal (after a login process not shown) at 308. This sets a timer T. Otherwise, the GC can open the bid terminal directly at 312, which also sets the timer T.

In either case, the bid terminal display is activated to display a dynamically populated web page that summarizes the bid activity by providing an entry for each bid response received at 308. In accordance with the current embodiment, these bid responses cannot be deleted by the subcontractor, or the supplier until the RFP is deleted by the General Contractor, or 30 days has lapsed from the closing date and time. The web page contains links to detailed bid documents, insurance certificates, prequalification information and company data. Each bid is identified and tracked by a secure, random ID. The GC can then view and/or print the data as desired at 314 and the process exits at 316.

The timer that was set at 306 or 312 operates to cause a periodic refresh of the data displayed on the bid terminal. In one embodiment, the timer periodically decrements at 318 and when the timer reaches 0 (by counting down for, e.g., one minute) at 320, the bid terminal is updated at 324 and the timer is reset at 326. The timer then proceeds to decrement again so that at periodic short intervals, the bid terminal is updated to reflect the latest bid responses to arrive.

Further details of several aspects of the Bidrunner™ exemplary bid system are provided below:

Real-Time Contact Manager: Because the General Contractor, subcontractors and suppliers are linked through private Internet Communication Tunnels, and able to transmit RFPs and RBs quickly, they can also link together to share “Real-Time” Contact Information. This is very different than static, PC based software systems, in which Contact Information has to be manually added and becomes obsolete the moment one party changes an email, fax number, the name of their company, etc. Within the Bidrunner™ system's Contact Manager, any changes that are made to one party's company information, is immediately recognized in the system and is available to those that have been allowed permission to view such information. This means that current pre-qualification and insurance information is available to the General Contractor anytime, from anywhere, simply with an Internet connection. This is especially important for Government procurements, in which M/WBE, DBE, and other minority or disadvantaged firms, need to be more visibly recognized as participants in the bidding process. Also, General Contractors can supply the example Bidrunner™ system with their own obsolete contacts lists. The Bidrunner™ system uploads these into separate tables and runs a program that fills in missing information. This can often be done in a quite efficient manner, especially in certain areas, because of the large number of subcontractors and suppliers present in the database.

Bid Day Terminal: Bids arrive to GC instantly, without quantity limitations. This allows them to make faster, better decisions regarding the project, with much more information and better communication lines open across the GC, Sub, and supplier relationship.

General Contractors Posting Public RFPs: If desired, a General Contractor has the opportunity to post a public RFP on the example Bidrunner™ system (This RFP is not made available privately to subcontractors or suppliers, as above, but instead resides on the bid system for selected viewing by a wide range of subcontractors or suppliers. This RFP cannot be seen by other General Contractors, but is made available for all subscribing subcontractors and suppliers to view/print/save and send a Response Bid if desired. These are tracked in a similar manner to the above scenario.

Ability To Link RFP To 3^{rd} Party “Planning Room”: There are other companies with software applications that re-create digital “Planning Rooms,” which house architectural drawings and allow the subcontractors and suppliers to open a browser and peruse the diagrams—this helps simplify what is known as a “take-off,” allowing subcontractors or suppliers to better arrive at their Response Bid (RB). The current embodiment of the bid system allows the General Contractor, when preparing to send an RFP, to place a URL in a form field that links a particular Document to a 3^{rd} party “planning room” that is specific to that RFP.

M/WBE, DBE OR any Minority or Disadvantaged Enterprise Reporting: Because all RFP and RB information is compiled for General Contractor, who can now view his/her RFPs and corresponding Response Bid information from specific subcontractors or suppliers, output pages can be generated and viewed/printed/saved by General Contractor, or sent to a specific Government agent in charge of minority contracts.

Giving All Parties a More Commercial Look: Because dynamic WebPages are created “on-the-fly,” General Contractors, subcontractors, and suppliers can be are given the opportunity to customize their particular output pages—uploading company descriptions, logos, company photos, etc. This creates a much more commercial look and feel than the current faxing and email attachment systems, which dilute the creative and distinctive look of the transmission.

Intent to Bid: subcontractors/suppliers are able to click a button to let GC know that they intend to bid on a project. This information is tracked in GCs Administration Panel, and spreadsheets.

Bid Acceptance: GC can notify subcontractors or suppliers instantly that their bid was tentatively accepted.

Government Agency Invitations to Bid: Public agencies can post public, monthly “Lettings.” Government agencies can see who of their minority contractors are receiving RFPs, and as well, whom of those minority firms are actively participating in their programs. Additionally, agencies can monitor what is called “Migration.” This is when a minority sub or supplier is transferred into a General Contractors private, non-mandated database in the example Bidrunner™ system. The Bidrunner™, for example and other embodiments consistent with the present invention are the only systems capable of doing this, because of its inherent virtual private network structure.

The construction bid system and method described above can be implemented using web based technology, with the user interacting with various screen images for data input and output. The following several figures depict exemplary screen shots used in an exemplary commercial embodiment consistent with the present invention. However, it will be clear to those skilled in the art that many variations are possible. For example, the various screens shown are not intended to be all inclusive of all possible screens on a given implementation.

Moreover, any number of variations on the arrangement of the data and input screens can be devised. While the individual screen images of this embodiment can be navigated in the manner described, other arrangements are also possible, so that a user can use any number of variations in the menu hierarchy to get to any given screen image, input screen, or output data. Such arrangements can be layered in a deep or shallow hierarchy, or may even be presented as a flat arrangement that can be directly accessed from a single menu without departing from embodiments consistent with the present invention. Many variations will occur to those skilled in the art upon consideration of the present teachings.

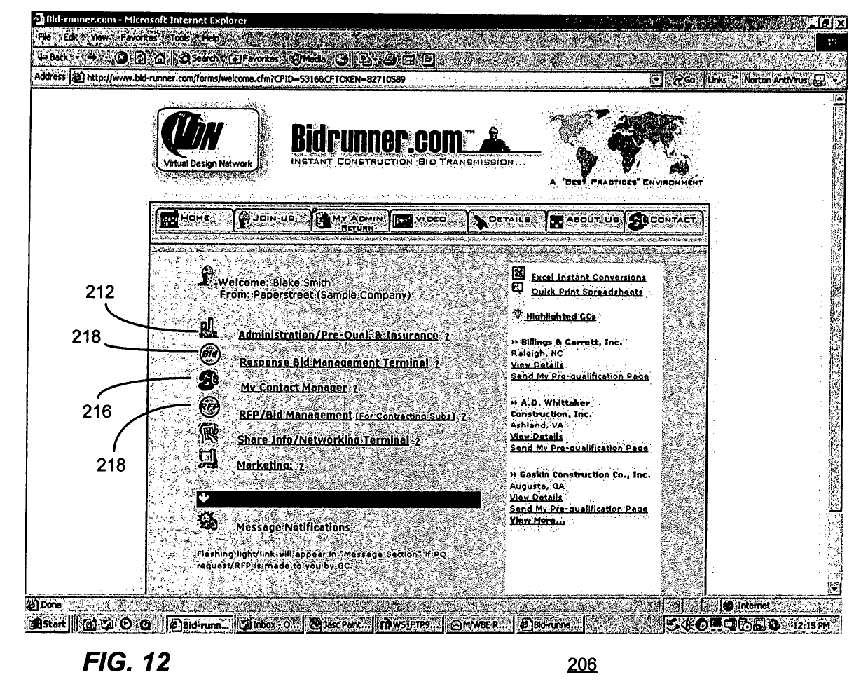

FIG. 12 is an exemplary home page of a bid system for a subcontractor or supplier consistent with certain embodiments of the present invention. Somewhat similar pages are provided for GCs, and government agencies. The user arrives at this location after carrying out a login process using a user name and password. In this embodiment, the company information selection 212, contact manager 216, RFP/RB manager selection 218 and bid day terminal 220 are depicted along with several other menu selections. As can be seen from review of this embodiment, many other peripheral functions (networking, marketing, etc.) can be incorporated in addition to the peripheral functions shown in FIG. 5 (e.g., 214 and 224).

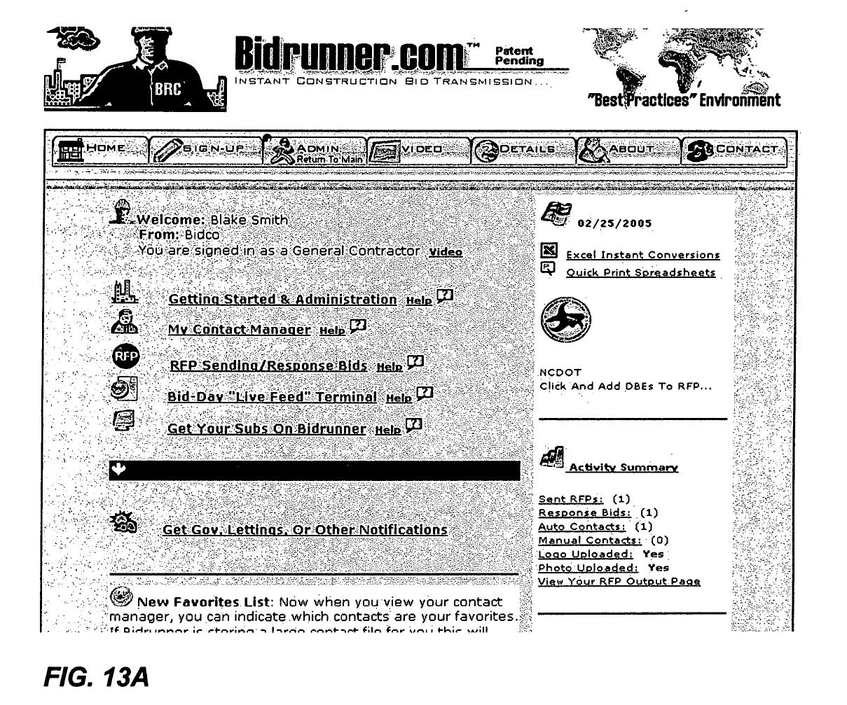

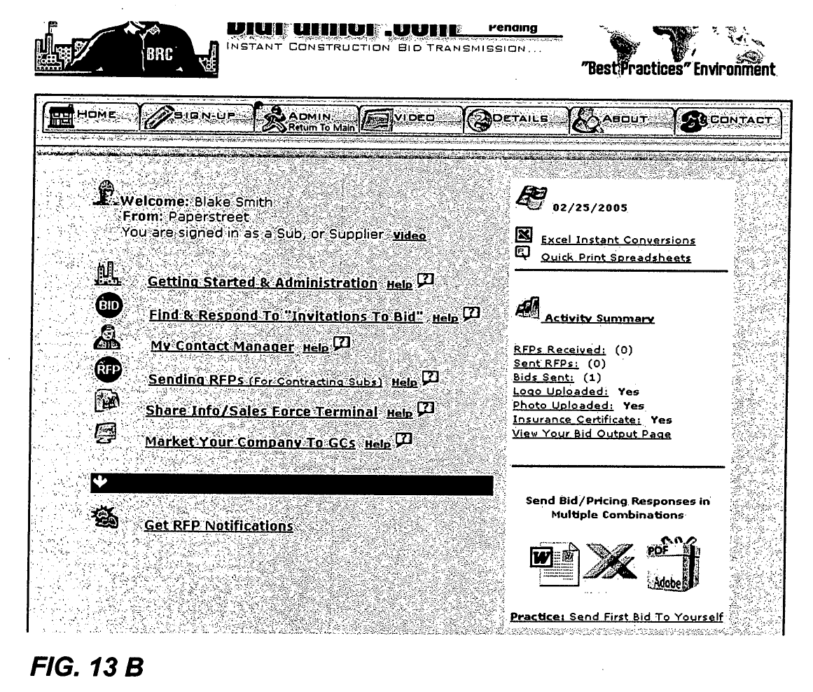

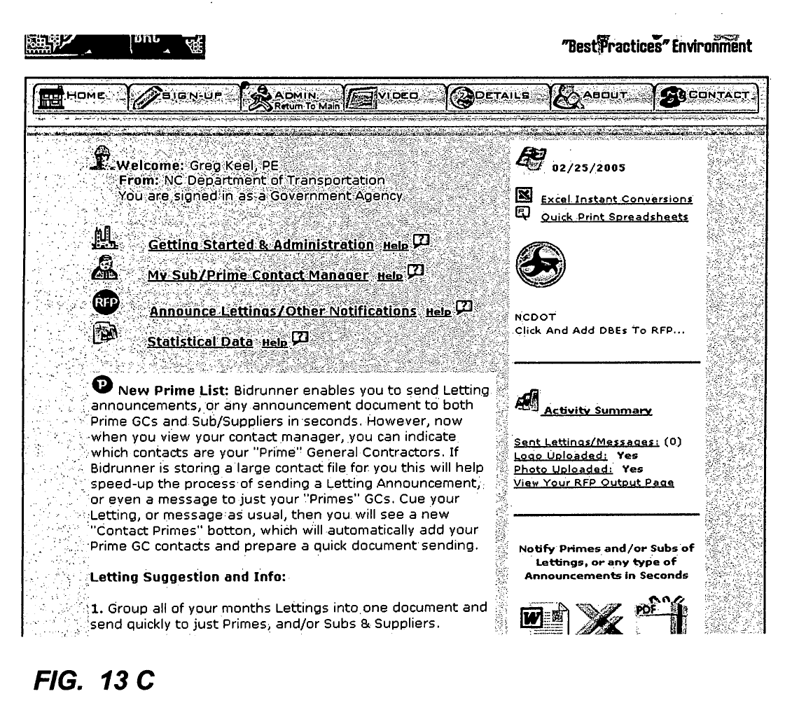

A General Contractor Administration Panel is depicted in FIG. 13A. General Contractors do not have full pre-qualification information to be filled out, or insurance certificates to load in this embodiment. They also, can only send public and private RFP and cannot send Response Bids, in accordance with the present embodiment.

A Subcontractor and Supplier Administration Panel is depicted in FIG. 13B. Subs and suppliers have every aspect of a GCs capabilities, because they may be contracting subcontractors (using their own identified subs). They have an expanded Pre-qualification form and the ability to send it to General Contractors in and out of the Bidrunner™ system, thus marketing themselves. They can respond to RFPs with a bid.

A Government Agency Administration Panel is shown in FIG. 13C. Government Agencies supply the example Bidrunner™ system with their “Prime Contractor” and M/WBE and DBE (or other disadvantaged businesses) lists. These are loaded into a separate table. Agencies can take a pro-active role to send just their “Prime Contractors” or “Primes and Minority or other disadvantaged firms” all of that State's lettings. They can monitor under “Statistical Data” each minority firm, how they are responding to RFPs and how they are “Migrating” onto other General Contractors private contact managers. Such information provides governmental agencies valuable data that can be used to establish goals for use of such disadvantaged businesses (such goals are commonly set by no more than an educated guess). Progress can be gauged by migration information. This permits government agencies to know with greater level of certainty what percentage of disadvantaged businesses are available to do a particular type of task (e.g., electrical work or grading contractors), and further gives an indication of progress toward those businesses receiving a reasonable share of the work. Moreover, by the government agencies uploading their lists of disadvantaged contractors, subs and suppliers into the database, such contractors are more readily available to general contractors for use, and they receive greater exposure than would otherwise be possible. General Contractors are then further motivated to use systems such as those consistent with the present invention in order to assure that good faith efforts are being made to utilize such disadvantaged businesses and thereby not run afoul of relevant laws and regulations.

Several of the links in this screen and the functions they carry out for the GC are explained below. The titles used in this embodiment varies depending on the nature of the user (GC, contracting subcontractor or subcontractor), but generally the links described below carry out the actions described when reached by whatever menu selection name. Also, the applicability of the particular selection to which of the administration screens of FIGS. 13A, 13B and 13C is indicated in parenthesis prior to the description.

1. Administration/Prequalification and Insurance OR Company Info and Administration (212)

Add/Edit Your Information: This link takes you to an area that allows you to view, add, edit your company information. In the current embodiment, if you change your email address, it will change your log-in name, which is your email address, to enter the site.

View Your RFP Output Page . . . : This link allows you to view your RFP output page, as subcontractors or suppliers will see it. This includes your company contact information, email link, website link, company description, company logo, and a company photo—all which track with all RFPs that you create and deliver.

Upload Company Logo: This link takes you to an area in which you can upload a company logo, in JPEG format, which has been stored on your local computer.

Upload Company Photo: This link takes you to an area in which you can upload a company photo, in JPEG format, which has been stored on your local computer.

Change Passcode: This link is where you go to change your passcode (password). This should be done regularly, as a matter of security.

Add/Edit Your Pre-qualification Information Subs/Suppliers Only: This link takes you to a comprehensive, multi-page form that allows you to show General Contractors what you've done and what you are capable of doing for them. This information is only shared with GCs when you send a bid, or when you give permission (you can give, or take away permission at any time). Pre-qualification information can be changed at any time. If there is some information which you don't want to share, it will show up as “Not Specified.”

View Your Bid Output Page Subs/Suppliers Only: This link allows you to view your Bid output page, as subcontractors or suppliers will see it. This includes your company contact information, email link, website link, company description, company logo, and a company photo—all which track with all RFPs that you create and deliver. This also includes your comprehensive Pre-qualification information and insurance certificate, if uploaded.

View Your RFP Output Page (For Contracting Subs): This link allows you to view your RFP output page, as subcontractors or suppliers will see it. This includes your company contact information, email link, website link, company description, company logo, and a company photo—all which track with all RFPs that you create and deliver.

Print/File My Own Pre-qualification Text Document: This link allows you to print and file your own Pre-qualification information for reference, or use.

Upload Company Logo: This link takes you to an area in which you can upload a company logo, in JPEG format, which has been stored on your local computer.

Upload Company Photo: This link takes you to an area in which you can upload a company photo, in JPEG format, which has been stored on your local computer.

Upload Insurance Certificate (Subs/Suppliers Only): This requires you to scan, or have scanned a copy of your umbrella insurance certificate, if available. This is uploaded from your computer and is available with every bid you send.

Quick Send Certificate (Subs/Suppliers Only): If uploaded, this allows you to send anybody, in or out of the system, your insurance certificate in just a few seconds.

Marketing to GCs (Subs/Suppliers Only)

(Sub/Suppliers Only) Send Instant Pre-qualification To Any GC: This allows you to send your entire output page, with website links, email links, and all Pre-qualification information to any GC in just a few seconds.

(Sub/Suppliers Only) Search Bidrunner™ GCs And Send Pre-qualification: This allows you to search all GCs in the Bidrunner™ system and send them a Pre-qualification.

Change Passcode: This link is where you go to change your passcode (password). This should be done regularly, as a matter of security.

II. My Contact Manager (216)

Automatically Build “My Contact Manager”: This link allows you to search the bid system's subcontractor or supplier database and locate companies. With the click of your mouse, you can add them to your contact manager, or request a full pre-qualification. If the latter is chosen, you will be given access to comprehensive qualifying information, which includes company structure, M/WBE, bonding information, personnel, financial, drug & safety information that is available to you 24/7. This information will also track with every bid this contact sends to you. In both cases, either a simple contact add or full pre-qualification, every time these companies update their information, it is immediately updated in your Contact Manager. This manager is then used to send RFPs.

Manually Add Subcontractor or supplier Contacts: This link allows you to add contacts manually to the system, much in the same way you would if you are familiar with static, PC based faxing and email attachment bid software. These contacts are not dynamically updated. This is an important reason to suggest to your subcontractors or suppliers that they start using the Bidrunner™ system to send you their Response Bids.

Have Them Add Themselves: This link allows you to instantly create an Outlook™ email message, and forward it to your Outlook™ contacts, which includes a link to a dynamically generated web page that is specifically yours. When the recipients of this email click the link, it takes them to your dynamically generated contact information page. They fill in their current information themselves, click the submit button, and the information is immediately loaded into your manual contact manager database.

View/Edit My List: This link assembles all of the contacts in your database, along with all of the information available on them. This list can be instantly converted to an Excel™, or HTML based spreadsheet to view/print/save.

View Who's GC Lists I'm On (Subs/Suppliers Only): This link assembles all of General Contractors that currently have you on their private contact manager list.

III. RFP Sending/Response Bid Management (218)

RFP Terminal: Total RFP Posting & Delivery . . . : This link guides you through a very comprehensive, easy to use, RFP posting and delivery system.

Post your RFP: Fill out short form that gives information on the RFP name, number, location, closing dates and times, needed CSI division, and specific CSI numbers. You have the option of adding a link to a extraneous planning-room, or PDF, or other page that may be of interest to those viewing your RFP. Upload the actual RFP Word Doc. that you have already created. Click “Submit.”

Query your Contact Manager and other options: Your new RFP, its corresponding web output page, and a summary of the RFP information, is already viewable to you. You now have the option of posting this RFP semi-publicly in the bid system—for only subscribing subcontractors or suppliers to view, not other GCs. You have the option to send it to yourself, so that it can be forwarded through your Outlook™ Email Manager—without needing an attachment. You can now query/search your Contact Manager database in order to deliver a mass delivery of your RFP notification. You are able to search by State, Company Name, City, General CSI Divisions, Specific CSI Codes, Geographic Business Area of Companies. These searches can handle multiple selections in each category. Also, you are able to go back and re-search, add, and delete contacts at will. M/WBE companies show up in red. Additionally, you are able to view the company details of your contacts on the fly.

View your final “Recipient” list selections: This section allows you to remove any last minute contact who you do not want to receive the RFP. You have the option of clearing the list and starting over, or adding contacts. When you are happy with the list, you click the submit button.

Instant RFP notification to Bidrunner™ Subcontractors or suppliers and Excel™ & HTML spreadsheet generation: This event triggers notification lights in the bid system's subcontractor or supplier subscriber Administration panels, along with the secondary notification by a non-attachment email that has a link to your RFP output page. Those contacts that do not subscribe to bid system, but were in your Manual Contact database, receive a non-attachment email with a link to your comprehensive RFP output page. All parties can click this link and view/print/save the RFP, at will. At this point you can also generate an Excel™, or HTML spreadsheet—this includes details on your RFP and a list of who received it.

Subcontractor or supplier intent to bid: From the RFP email, or through their Administration panel, both system and Manual Contacts can click a button if they intent to bid on this project. This “Yes” “No” is captured and becomes part of your viewing and reporting panels and spreadsheets.

Response Bids & Open Bid Section (Subs/Suppliers Only): Response Bids sent through the Bidrunner™ system to a posted, or un-posted RFP, are immediately available to you in a couple of places on your Administration panel. For historic or casual viewing and passive report generation, the easiest place to find and compile these is in your RFP History section—discussed below. NOTE: Maybe you didn't send your RFP out through the Bidrunner™ system, or a subcontractor or supplier didn't link into your posted RFP in the exemplary Bidrunner™ system; but instead, sent a response bid through a simple query of GC in his/her Administration panel/Contact Manager. This means that this particular Response Bid was not attached to a specific RFP for tracking purposes. This is not a problem in the current embodiment since the bid system identifies these “Open” Bids and compiles them into an independent report, complete with their own Excel™ or HTML format spreadsheet.

RFP History: Generate RFP Response Bid Reports (Subs/Suppliers Only): In this area you can view all of your RFPs. Your RFPs are kept in the database for 30 days after closing date. You can choose an RFP and you will be given a listing of all Response Bids that have come in on that particular RFP posting. You can generate, at any time, an Excel™ or HTML format spreadsheet with up-to-the-minute information on every aspect of that company and their corresponding bid.

MWBE/DBE or Other Disadvantaged Enterprise Report: In this area you can choose an RFP from among your sent RFPs, compile them with corresponding bids, same as above. This time, however, you can send a new web output page to the Government Administrator of that particular project. This instant transmission has all view/print/save details on the original RFP, all view/print/save aspects of the Response Bids and pre-qualification information, all recipients of the RFP and who intended to bid. All of this information can be converted by the Government Administrator instantly into an Excel™ or HTML format spreadsheet. This makes it advantageous for government administrators to make sure that their minority clients are subscribers to the bid system.

IV. Bid-Day Terminal (220)

Bid-Day Terminal: “Live Feed” Of Response Bids To RFPs Sent Internally: This area demonstrates the ability of the bid system to process and instantly notify General contractors of incoming Response Bids. On Bid-day, responses to an RFP posted through the bid system as provided by subcontractors and suppliers can be viewed as they arrive. Additionally, at any time during this incoming bid scenario you can view/print/save any aspect of the bid, the pre-qualifications, or insurance information. You can also generate a instant Excel™ or HTML format spreadsheet.

V. Marketing

Get Your Favorite Subcontractors or Suppliers In Your Contact Manager—Automatically (General Contractors Only): This link is also available in your Contact Manager, and may provide you with a good marketing tool—which will help you introduce your favorite subcontractors or suppliers to the bid system; and consequently, make your Bid-days easier. This link allows you to instantly create an Outlook™ email message, and forward it to your Outlook™ contacts, which includes a link to a dynamically generated web page that is specifically yours. When the recipients of this email click the link, it takes them to your dynamically generated contact information page. They fill in their current information themselves, click the submit button, and the information is immediately loaded into your manual contact manager database.

Send Emails/“Last Fax” To Your Favorite Subs & Suppliers (General Contractors Only): This link gives you ideas on how to reach your subcontractors or suppliers with the Bidrunner™ system message, via emails; and there is a sample Fax letter available there for use.

Links for subcontractors and suppliers are explained below:

1. Company Info & Administration OR Administration and Prequalification & Insurance

Add/Edit Your Pre-qualification Information: This link takes you to a comprehensive, multi-page form that allows you to show General Contractors what you've done and what you are capable of doing for them. This information is only shared with GCs when you send a bid, or when you give permission (you can give, or take away permission at any time). Pre-qualification information can be changed at any time. If there is some information which you don't want to share, it will show up as “Not Specified.”

View Your Bid Output Page: This link allows you to view your Bid output page, as subcontractors or suppliers will see it. This includes your company contact information, email link, website link, company description, company logo, and a company photo—all which track with all RFPs that you create and deliver. This also includes your comprehensive Pre-qualification information and insurance certificate, if uploaded.

View Your RFP Output Page (For Contracting Subs): This link allows you to view your RFP output page, as subcontractors or suppliers will see it. This includes your company contact information, email link, website link, company description, company logo, and a company photo—all which track with all RFPs that you create and deliver.

Print/File My Own Pre-qualification Text Document: This link allows you to print and file your own Pre-qualification information for reference, or use.

Upload Company Logo: This link takes you to an area in which you can upload a company logo, for example in JPEG format, which has been stored on your local computer.

Upload Company Photo: This link takes you to an area in which you can upload a company photo, for example in JPEG format, which has been stored on your local computer.

Upload Insurance Certificate: This requires you to scan, or have scanned a copy of your umbrella insurance certificate, if available. This is uploaded from your computer and is available with every bid you send.

Quick Send Certificate: If uploaded, this allows you to send anybody, in or out of the system, your insurance certificate in only a few seconds.

Change Passcode: This link is where you go to change your passcode. This should be done regularly, as a matter of security.

II. Response Bid Terminal (218)

RFP Notification Alert Light: If an RFP is sent to you through a Bidrunner™ subscribing GC, you will be notified with a blinking light in the main area of your Administration panel. Click on the link and you will be able to view/print/save the RFP. You can indicate to the GC if you intend to bid on this RFP. You can send a Response Bid be simply clicking the “Respond with a Bid” link. It will pre-populate the details of the RFP in your bid form. Upload your bid document (e.g., in Microsoft Word™ format) and click submit. Your bid is instantly available to the GC. A secondary non-attachment email is sent, with a link to your bid output page, is also sent.

Search System For GC & Send Open Bid Instantly: It's here that you search the entire system for General Contractors and can send them a bid. This bid doesn't have to be associated with an internal GC submitted RFP—you may have heard about it somewhere else. Fill out the short form, which includes RFP name, number location, etc. Upload your bid document (e.g., in Microsoft Word™ format) and click submit. Your bid is instantly transmitted. A secondary non-attachment email, with a link to your bid output page, is also sent to notify GC.

Send Instant Bid To Any GC: This is primarily used to send bids to GCs that are outside the bid system. Fill out the short form, which includes RFP name, number location, etc. Upload your bid document (e.g., in Microsoft Word™ format) and click submit. Your bid is instantly transmitted. A secondary non-attachment email, with a link to your bid output page, is also sent to notify GC.

View RFPs Sent To Me: This link corresponds with your “Blinking Light” link, detailed in the Response Bids Terminal. It allows you to view RFP that have been sent to you by the

Bidrunner™ system GCs at any tine and respond with a bid. View Bid History: View your bid history. Bids cannot be deleted until at least 1 day after the closing date, in this implementation. All bids and details can be converted to an Excel™ or HTML format spreadsheet on-the-fly.

Send A Residential Proposal To Homeowner: This form is a slight variation on the Commercial bid form, with recipient name and email. Upload your bid document (e.g., in Microsoft Word™ format) and click submit. A special residential web output page with your bid link is sent—however, it does not include Pre-qualification information. You can view this special page next to the main link in your Administration panel.

III. My Contact Manager (216)

Pre-Qualification Request Alert Light: If a GC in the bid system requests a pre-qualification from you, a notification light will flash in the main panel of your Administration screen. You will have the opportunity to accept, or deny this transfer. Acceptance will also place you in their contact list. You can change this decision at any time.

Who's Contact Lists Am I On?: This link allows you to view which GCs have included you in their Contact Manager. This could be a “simple inclusion,” which means that only basic contact information is available to the GC. Or, the GC may have requested a Pre-qualification from you at some time, to which you accepted the transfer. Either way, you can decide to include, or exclude your pre-qualification information in any GCs Contact Manager at any time. You can also convert this information to an Excel™ or HTML format spreadsheet.

View All General Contractors In System: This is a passive link, which allows you to peruse the General Contractors in the bid system. However, you use the Bid Terminal to send these GCs a bid, or Pre-qualification.

Automatically Build “My Contact Manager” (Contracting Subs): This link allows you to search the bid system's subcontractor or supplier database and locate companies. With the click of your mouse, you can add them to your contact manager, or request a full pre-qualification. If the latter is chosen, you will be given access to comprehensive qualifying information, which includes company structure, M/WBE, bonding information, personnel, financial, drug & safety information that is available to you 24 hours per day, seven days per week. This information will also track with every bid this contact sends to you. In both cases, either a simple contact add or full pre-qualification every time these companies update their information, it is immediately updated in your Contact Manager. This manager is then used to send RFPs.

Manually Add Subcontractor or supplier Contacts: This link allows you to add contacts manually to the system, much in the same way you would if you are familiar with static, PC based faxing and email attachment bid software. These contacts are not dynamically updated. Thus, subcontractors and suppliers should use the bid system to send you their RBs.

Have Them Add Themselves: This link allows you to instantly create an Outlook™ email message, and forward it to your Outlook™ contacts, which includes a link to a dynamically generated web page that is specifically yours. When the recipients of this email click the link, it takes them to your dynamically generated contact information page. They fill in their current information themselves, click the submit button, and the information is immediately loaded into your manual contact manager database.

View/Edit My List: This link assembles all of the contacts in your database, along with all of the information available on them. This list can be instantly converted to an Excel™ or HTML based spreadsheet to view/print/save.

IV. RFP Terminal for Contracting Subs (218)

RFP Terminal: Total RFP Posting & Delivery: This link guides you through a very comprehensive, easy to use, RFP posting and delivery system.

Post your RFP: Fill out short form that gives information on the RFP name, number, location, closing dates and times, needed CSI division, and specific CSI numbers. You have the option of adding a link to a extraneous planning-room, or PDF, or other page that may be of interest to those viewing your RFP. Upload the actual RFP document that you have already created and click “Submit.”

Query your Contact Manager and other options: Your new RFP, its corresponding web output page, and a summary of the RFP information, is already viewable to you. You now have the option of posting this RFP semi-publicly in the example Bidrunner™ system—for only subscribing subcontractors or suppliers to view, not other GCs. You have the option to send it to yourself, so that it can be forwarded through your Outlook™ Email Manager—without needing an attachment. Most importantly, you can now query/search your Contact Manager database in order to deliver a mass delivery of your RFP notification. You are able to search by State, Company Name, City, General CSI Divisions, Specific CSI Codes, Geographic Business Area of Companies. These searches can handle multiple selections in each category. Also, you are able to go back and re-search, add, and delete contacts at will. M/WBE companies show up in red. Additionally, you are able to view the company details of your contacts on the fly.

View your final “Recipient” list selections: This section allows you to remove any last minute contact who you do not want to receive the RFP. You have the option of clearing the list and starting over, or adding contacts. When you are happy with the list, you click the submit button.

Instant RFP notification to Bidrunner™ subcontractors or suppliers and Excel™ & HTML spreadsheet generation: This event triggers notification lights in the bid system on subcontractor or supplier subscriber Administration panels, along with the secondary notification by a non-attachment email that has a link to your RFP output page. Those contacts that do not subscribe to the Bidrunner™ system, but were in your Manual Contact database, receive a non-attachment email with a link to your comprehensive RFP output page. All parties can click this link and view/print/save the RFP, at will. At this point you can also generate an Excel™, or HTML spreadsheet—this includes details on your RFP and a list of who received it.

Subcontractor or supplier intent to bid to contracting sub: From the RFP email, or through their Administration panel, both system and Manual Contacts can click a button if they intent to bid on this project. This “Yes” “No” is captured and becomes part of your viewing and reporting panels and spreadsheets.

Response Bids & Open Bid Section: Response Bids sent through the example Bidrunner™ system to a posted, or un-posted RFP, are immediately available to you in a couple of places on your Administration panel. For historic or casual viewing and passive report generation, the easiest place to find and compile these is in your RFP History section—discussed below. NOTE: Maybe you didn't send your RFP out through the bid system, or a subcontractor or supplier didn't link into your posted RFP in the bid system; but instead, sent a response bid through a simple query of GC in his/her Administration panel/Contact Manager. This means that this particular Response Bid was not attached to a specific RFP for tracking purposes. This is not a problem since the current embodiment of the bid system identifies these “Open” Bids and compiles them into an independent report, complete with their own Excel™ or HTML format spreadsheet.

RFP History: Generate RFP Response Bid Reports . . . : In this area you can view all of your RFPs. Your RFPs are kept in the database for 30 days after closing date. You can choose an RFP and you will be given a listing of all Response Bids that have come in on that particular RFP posting. You can generate, at any time, an Excel™ or HTML spreadsheet with up-to-the-minute information on every aspect of that company and their corresponding bid.

MWBE/DBE or Other Disadvantaged Entity Report: In this area you can choose an RFP from among your sent RFPs, compile them with corresponding bids, same as above. This time, however, you can send a new web output page to the government administrator of that particular project. This instant transmission has all view/print/save details on the original RFP, all view/print/save aspects of the Response Bids and pre-qualification information, all recipients of the RFP and who intended to bid. All of this information can be converted by the Government Administrator instantly into an Excel™ or HTML spreadsheet. This one reason is why it is advantageous for government administrators to make sure that their minority clients are subscribers to the bid system.

Bid-Day Terminal: “Live Feed” Of Response Bids To RFPs Sent Internally: This area, demonstrates the ability of the bid system to process and instantly notify General Contractors of incoming Response Bids. On bid-day, the responses to RFPs posted through the bid system are updated as they arrive so that one can see them appear instantly. Additionally, at any time during this incoming scenario you can view/print/save any aspect of the bid, the pre-qualifications, or insurance information. You can also generate a instant Excel™ or HTML format spreadsheet.

The following selections can be accessed using any of a variety of screens in the bid system containing links thereto.

V. Reports & Maintenance

View Bid History: View your bid history. Bids cannot be deleted until 1 day after the closing date. All bids and details can be converted to an Excel™ or HTML format spreadsheet on-the-fly.

View RFPs That Are Sent To My Administration Screen By Bidrunner™ GCs: This link corresponds with your “Blinking Light” link, detailed above. It allows you to view RFP that have been sent to you by subscribing GCs at any time and respond with a bid.

RFP History: Generate RFP Response Bid Reports . . . : In this area you can view all of your RFPs. Your RFPs are kept in the database for 30 days after closing date. You can choose an RFP and you will be given a listing of all Response Bids that have come in on that particular RFP posting. You can generate, at any time, an Excel™ or HTML spreadsheet with up-to-the-minute information on every aspect of that company and their corresponding bid.

MWBE/DBE and Other Disadvantaged Entity Report: In this area you can choose an RFP from among your sent RFPs, compile them with corresponding bids, same as above. This time, however, you can send a new web output page to the government administrator of that particular project. This instant transmission has all view/print/save details on the original RFP, all view/print/save aspects of the Response Bids and pre-qualification information, all recipients of the RFP and who intended to bid. All of this information can be converted by the Government Administrator instantly into an Excel™ or HTML format spreadsheet. This is one reason why it can be advantageous for government administrators to make sure that their minority clients are subscribers to the bid system.

VI. Marketing To General Contractors

Send Instant Pre-qualification To Any GC: This allows you to send your entire output page, with website links, email links, and all Pre-qualification information to any GC in only a few seconds.

Search Bidrunner™ GCs And Send Pre-qualification: This allows you to search all GCs in the bid system and send them a Pre-qualification.

With these functions defined, the following screen shots are illustrative of the Bidrunner™ system which is but one commercial embodiment consistent with the present invention. Other embodiments are also possible without departing from the present invention.

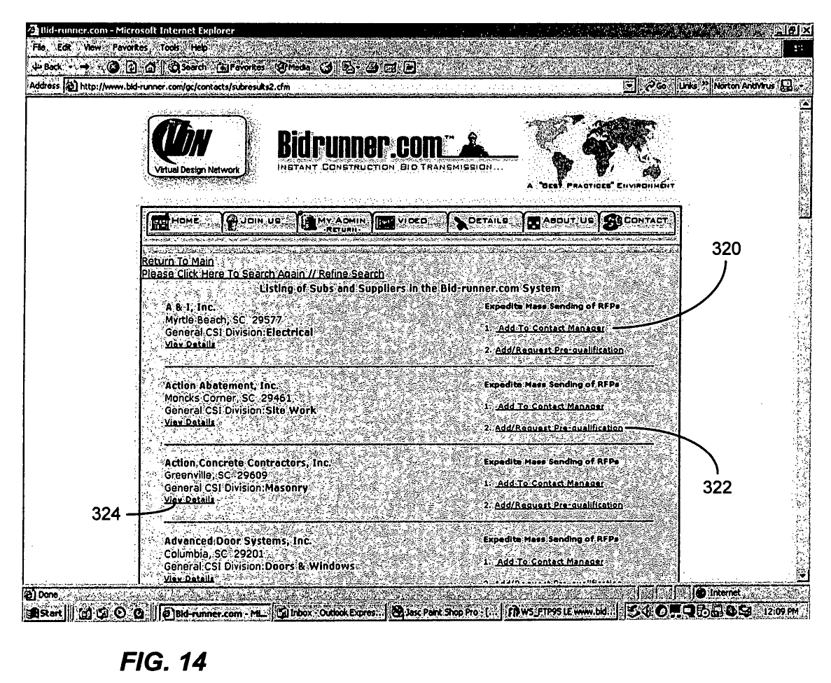

FIG. 14 is an exemplary screen shot of a list of subcontractors and suppliers available in a bid system consistent with certain embodiments of the present invention. In this screen, the user can add contacts to his contact manager by selecting the link 320 so that that company is available for easy selection to receive RFPs. Prequalification information can be requested by a GC by using link 322, and additional details of the company can be obtained from link 324. In the present embodiment, the user can navigate to this location from the contact management screen.

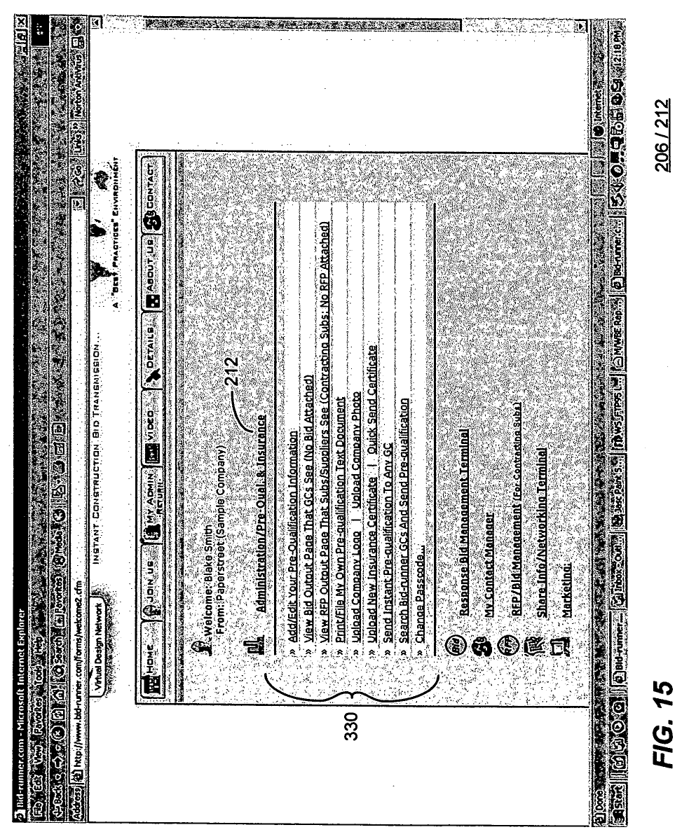

FIG. 15 is an exemplary screen shot depicting the expansion of the subcontractor/supplier administration screen selections when selection 212 is made from the main menu in a manner consistent with certain embodiments of the present invention. In the present embodiment, the user can navigate to this location directly from the main menu. When the administration selection 212 is made, the menu selections 330 are revealed from which the user can carry out any number of administrative activities, including, but not limited to, those shown and those previously described in connection with FIG. 9. It is noted that the administration screen for a GC operates in a similar manner, since the GC can at times act in the capacity of a subcontractor or supplier.

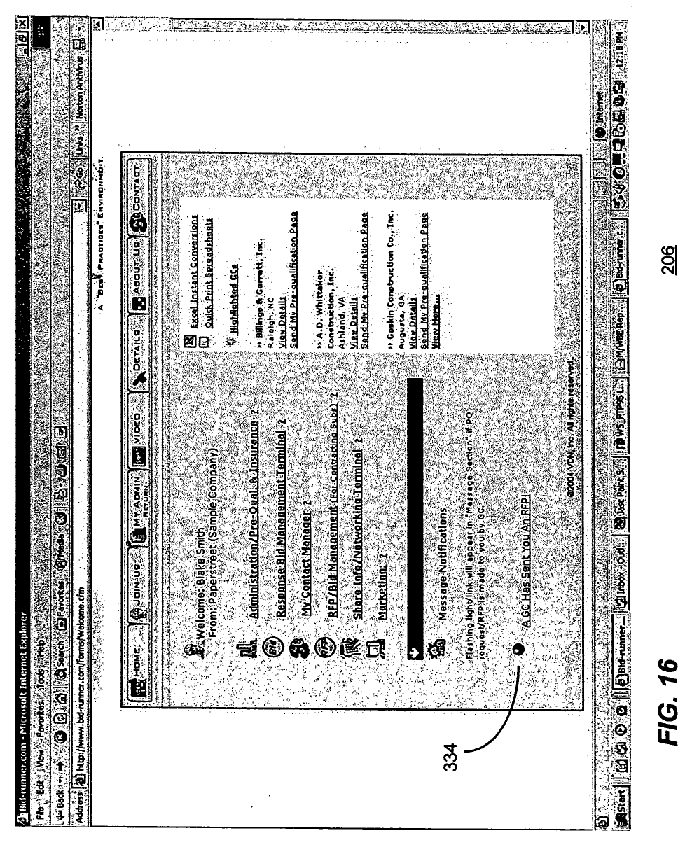

FIG. 16 is an exemplary home page of a bid system illustrating a notification of an RFP in a manner consistent with certain embodiments of the present invention. In this exemplary screen shot, the notification appears at 334 to indicate to the user that a GC has sent an RFP for the user's consideration.

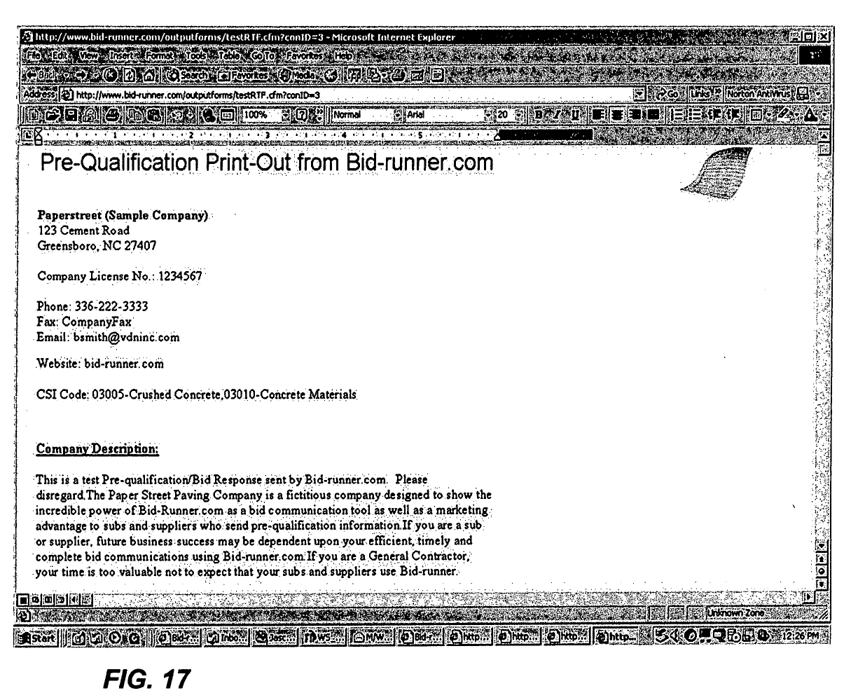

FIG. 17 is an example of a fictitious prequalification document that can be attached from the administration screen in a manner consistent with certain embodiments of the present invention as previously described.

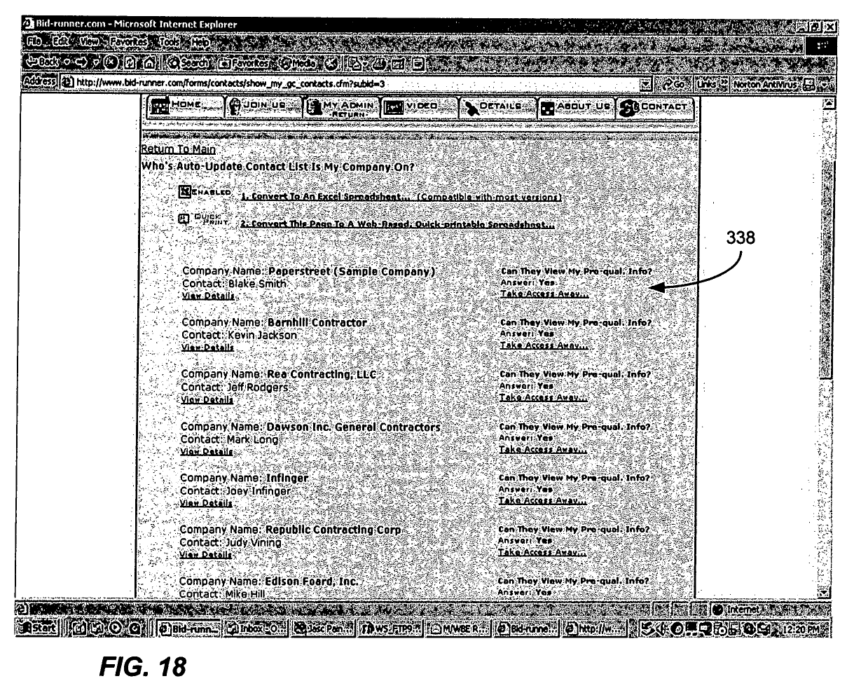

Once a subcontractor or supplier has filled in the contact information in the contact manager, he/she can view all of the contractors that have included his company in their contact manager. This is illustrated in FIG. 18, which is an example of a screen shot showing all of the GCs that have included a current subcontractor or supplier in their contact manager in a manner consistent with certain embodiments of the present invention. In addition, the subcontractor or supplier can use this screen to individually grant access to prequalification information or not to each GC on the list as shown at 338. This gives the subcontractor or supplier the ability to control access to information that might be considered by the subcontractor or supplier to be confidential.

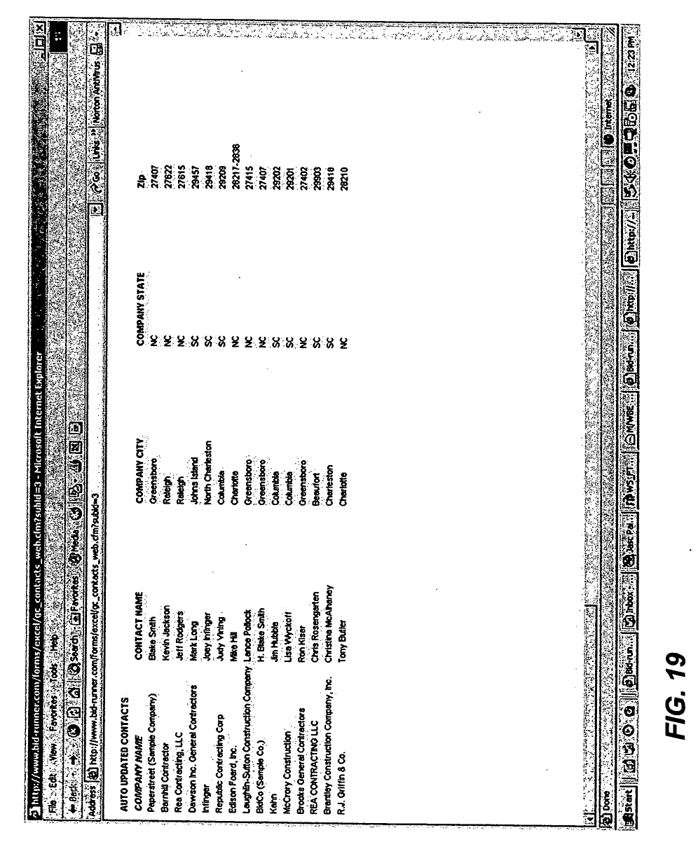

FIG. 19 is a sample report of contacts in the contact manager consistent with certain embodiments of the present invention. Such a report can be generated as a text, HTML or spreadsheet report. In the present embodiment, the user can navigate to this location by use of the contact manager link. The illustrated report contains only name and address information, but other information could also be displayed including telephone and email contact information. This type of report can be generated for all users without regard for status as a GC or subcontractor or supplier. In addition, the contact list can be used interactively to select subcontractors or suppliers or simply as a contact manager, in accordance with certain embodiments.

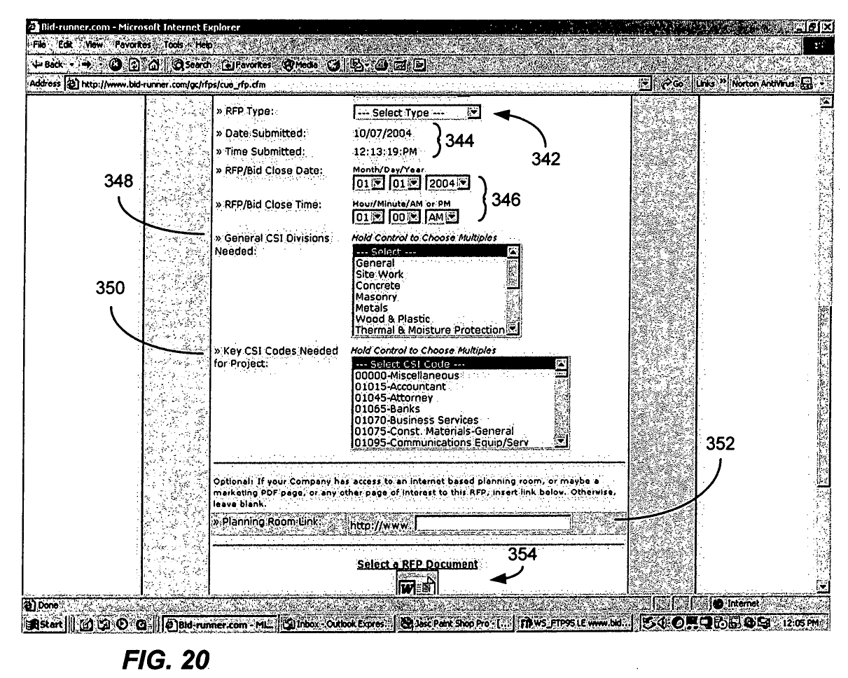

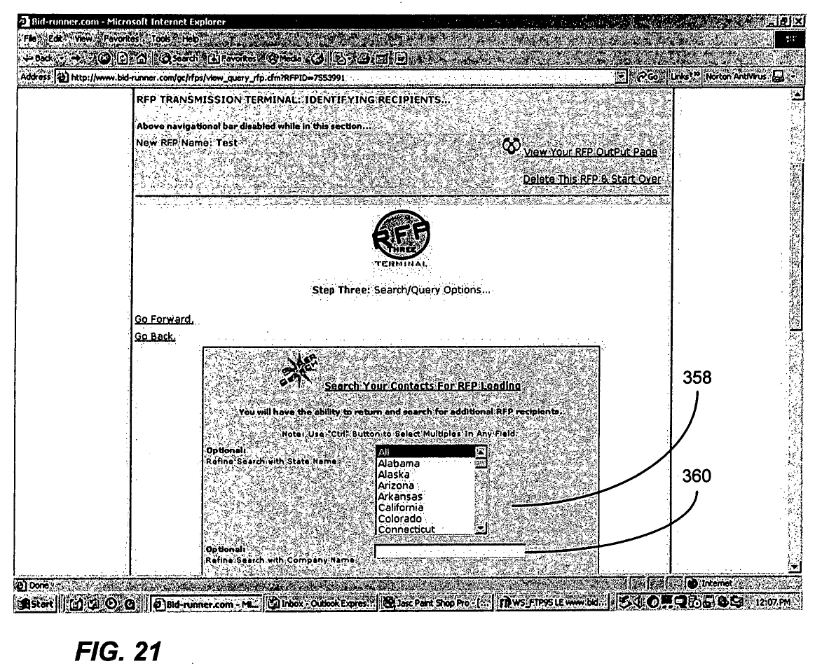

Referring to FIG. 20, a screen shot of a portion of an exemplary sample RFP data entry form used to create and submit an RFP is illustrated. In the present embodiment, the user can navigate to this location from the RFP sending terminal screen. Those skilled in the art will appreciate that other identifying information and other information can also be supplied using this screen in areas not shown. Once basic identification information is entered regarding the RFP, the GC navigates to this screen. In this screen, the GC can identify a type of RFP at 342 using a drop down menu. The date and time submitted are automatically tracked at 344 by the bid system. The bid close date and time are entered or selected by the GC using the pull down menus at 346. The type or types of work needed are selected by division and CSI code at 348 and 350, again in this embodiment, by using drop down menus and selecting from the available lists. Once the basic RFP has been assembled as described above, the user can select recipients for the RFP. FIG. 21 is a screen shot showing search and selection of subcontractors and suppliers for receipt of an RFP in a manner consistent with certain embodiments of the present invention. In the present embodiment, the user can navigate to this location from the RFP sending terminal screen. Various criteria can be used to identify potential subcontractors and/or suppliers to submit the RFP to. Area 358 illustrates a geographic search criterion that can be used, while area 360 can be used to search by company name. Other suitable search criteria could also be used as well as search by category of subcontractor or supplier, CSI codes, or manual review of all contacts in the contact manager, key word searches, or any other suitable search mechanism to identify potential recipients.

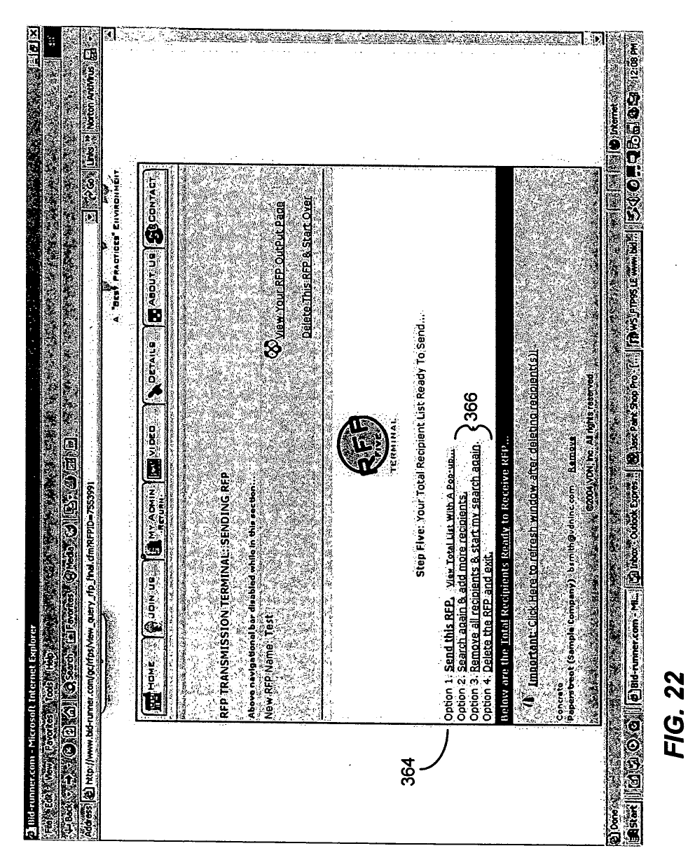

When all of the potential subcontractors and suppliers have been identified as described above, the GC moves to the screen depicted as FIG. 22. FIG. 22 is a screen shot of a screen used to send the completed RFP in a manner consistent with certain embodiments of the present invention. In the present embodiment, the user can continue navigation to this location by simply continuing the RFP generation process. The GC can send the RFP to all of the selected recipients by selecting 364. Alternatively, the GC can add more recipients, start over or simply exit at one of the selections at 366. If a planning room link is needed, the Internet address is entered at 352 to provide access to the planning room via the compiling of the RFP/Bid Response, i.e., these are private rooms, instantly created and have to involve two distinct parties. The RFP document and RB document itself is then identified by their random I.D. number, along with the random I.D. numbers of both the General Contractor and Subcontractor; and selected at 354 as a document stored on the computer or network from which the RFP has been prepared and submitted, along with a return bid from a subcontractor.

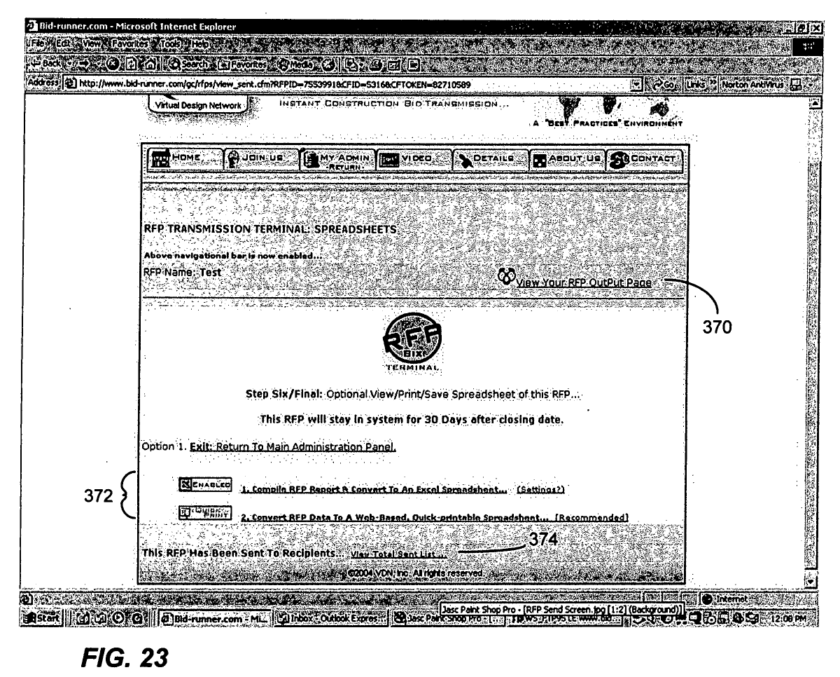

FIG. 23 is an example of a screen shot depicting a screen for viewing, printing or storing a copy of the RFP in a manner consistent with certain embodiments of the present invention. Once the GC completes sending the RFP to the recipients, he/she can review the output page by selecting 370; or may view, print or store the RFP in one of several spreadsheet formats by selecting 372. Additionally, the GC can review or print a list of the recipients of the RFP for later easy reference by selecting 374. In the present embodiment, the user can navigate to this location from the RFP terminal (after sending the RFP).

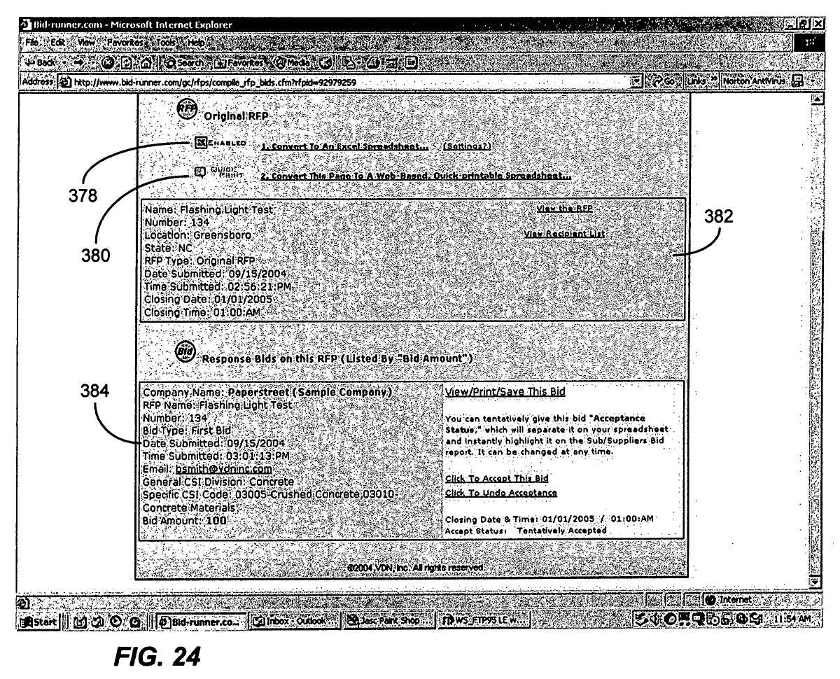

FIG. 24 is an example screen shot of an RFP and bid summary page consistent with certain embodiments of the present invention. In the present embodiment, the user can navigate to this location by use of RFP sent screen. Once the RFP is submitted to the selected recipients, and bid responses begin to arrive at the bid system, the GC can, at any time, view a summary screen such as the one presented here. This summary screen can be accessed from the RFP/RB management selection 218, and also resembles one view of the image that can be selected from the bid day terminal 220. In this view, selection of 378 produces a spreadsheet summary of the RFP. Selection of 380 generates a web based spreadsheet summary of the RFP's bid responses that can be printed easily for a quick preview. Area 382 provides an overview of the RFP with links to view details of the RFP or recipient list. Area 384 provides a summary of a bid response received for the current RFP. An area such as 384 is provided for each response. Area 384 also provides the ability to view, print or save the details of the bid and indicate acceptance or change the acceptance status of the bid for each received bid response.

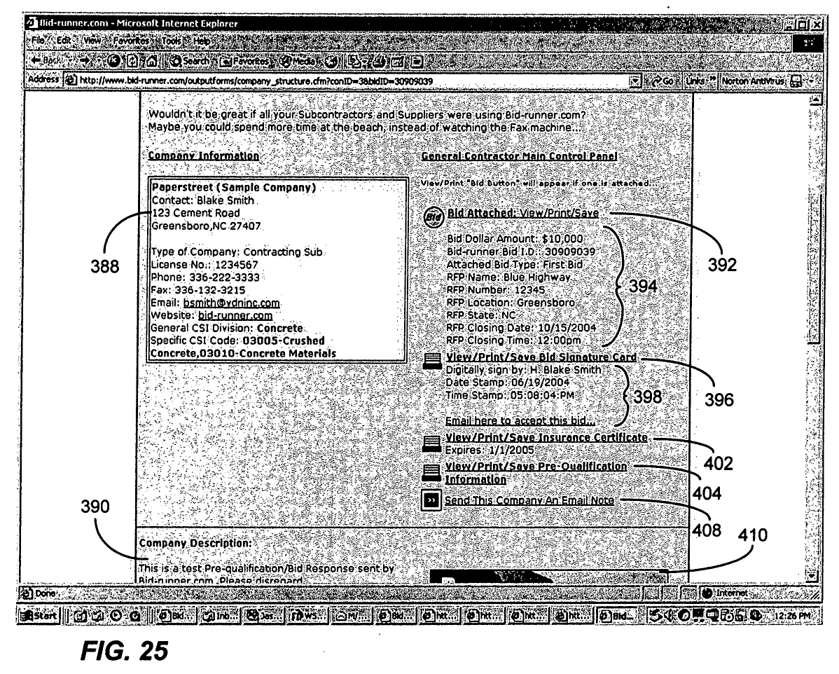

When a GC wishes to view the details of any particular bid, a screen shot such as that of FIG. 25 can be viewed in order to show details of a received bid. In the present embodiment, the user can navigate to this location by using the GC's RFP terminal and selecting the RFP he desires to view. A list of all response bids appear her and can be reviewed. The GC can view basic company information at area 388, and a more detailed company description at 390. The detailed bid document can be viewed, printed or saved by selecting 392. A summary of the bid is displayed in area 394. The subcontractor or supplier's signature card can be viewed by selecting 396. A summary of the digital signature is shown at 398 along with a link to email acceptance to the subcontractor or supplier. The insurance certificate(s) can be viewed, printed or saved by selecting 402, and similarly the prequalification information can be viewed, printed or saved by selecting 404. The company can be emailed by selection of 408. The company photograph (if any) appears at 410 and the logo (if any) can be viewed by scrolling down in a conventional manner.

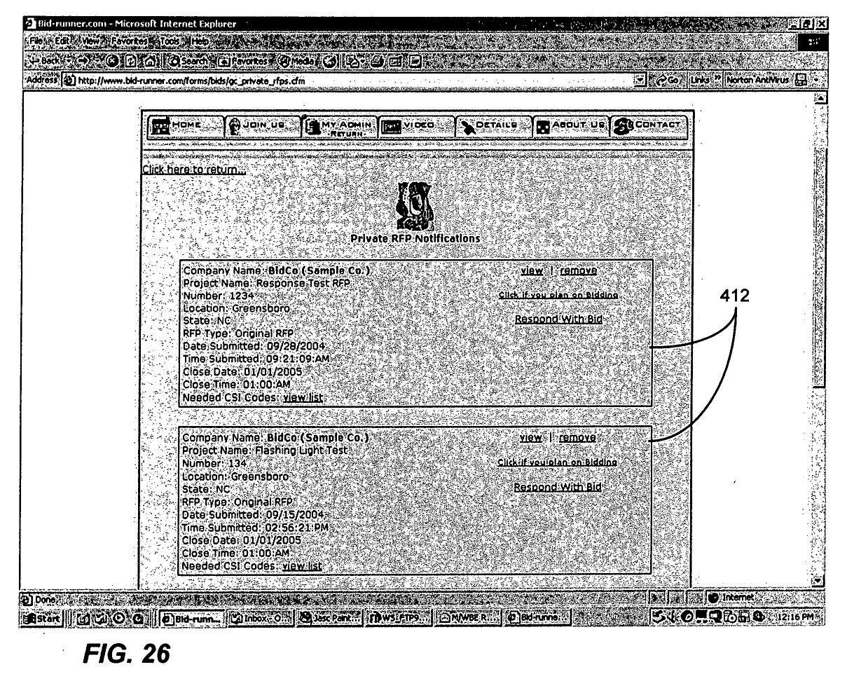

FIG. 26 is an example screen shot showing private RFP notifications. In the present embodiment, the user can navigate to this location as soon as lie logs in to the system, but can also access this at the bid sending terminal. In this screen, a subcontractor or supplier can view a summary of all RFP notifications received. One entry such as 412 is provided for each RFP, with each entry providing links that enable either deleting the RFP, responding with a bid or viewing the RFP details or indicating an intent to bid. A subcontractor or supplier can click on the blinking light. This light will go off as soon as they view the RFP webpage. Also they can retrieve all RFPs through the BID section of their Admin. Panel.

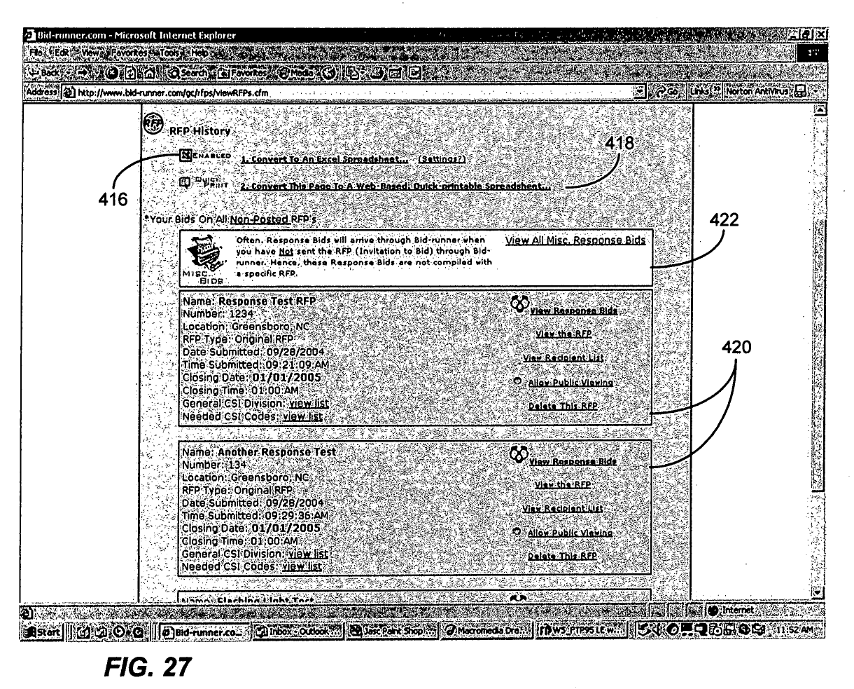

FIG. 27 is an example screen shot of an RFP history screen consistent with certain embodiments of the present invention. In the present embodiment, the user can navigate to this location by use of the RFP terminal by choosing to view all bids. A GC can gain an overview the history of outstanding RFPs using this screen. This view can be converted to a spreadsheet format for viewing, saving or printing by selecting 416, or can be converted to a web based (e.g., HTML) spreadsheet by selecting 418. Each RFP appears in summary form in its own area such as 420 which also supplies links to the RFP details, recipient list and response bids. Each area 420 also provides for deletion of the RFP from the system. Area 422 is also provided to enable a GC to receive unsolicited bids that might not be associated with any particular RFP.

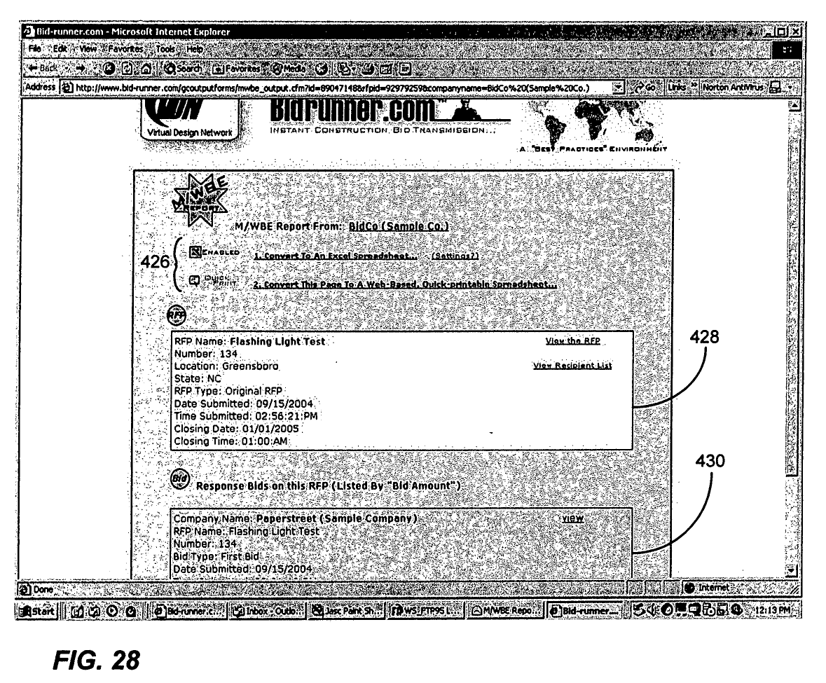

Government regulations in the U.S. provide various needs for reporting on the minority status of contractors and suppliers, depending on federal, state, county, or local city organization. FIG. 28 is an example of a screen shot depicting a M/WBE (Minority/Women Business Enterprise) report consistent with certain embodiments of the present invention. Other disadvantaged business reports could be generated in a similar manner. In the present embodiment, the user can navigate to this location by going to the RFP sending section of their Administration Panel. This screen enables easy tracking of bids received by minority businesses to assure compliance with applicable regulations. In this screen shot, a GC can view the minority status of each bidding enterprise along with information summarizing their bid response. In area 426, the GC can elect to view the report or save or print the report in either spreadsheet format or web based spreadsheet format. At area 428, the RFP is summarized with a link to view details, and an area 430 is provided for each bid response that summarizes the bid response and indicates the minority status of the bidder. In certain embodiments consistent with the present invention, response bids associated with minority businesses are highlighted by using a colored background, or in the case of a spreadsheet, using colored text along with a text indicator of the M/WBE/DBE (etc.) status of the subcontractor or supplier. Areas 430 also provide a link to view the details of the bid response, which produces a view such as that of FIG. 25.

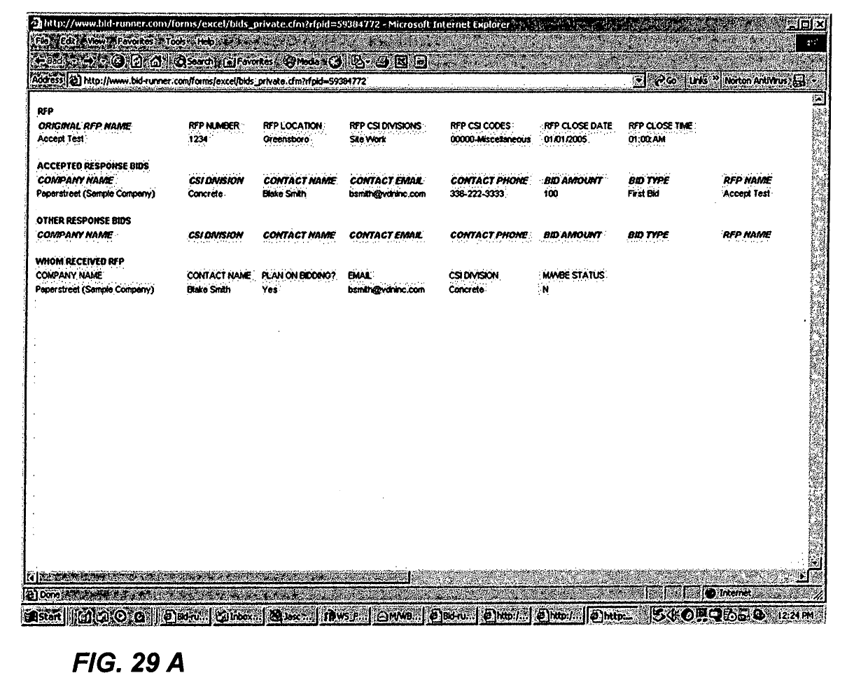

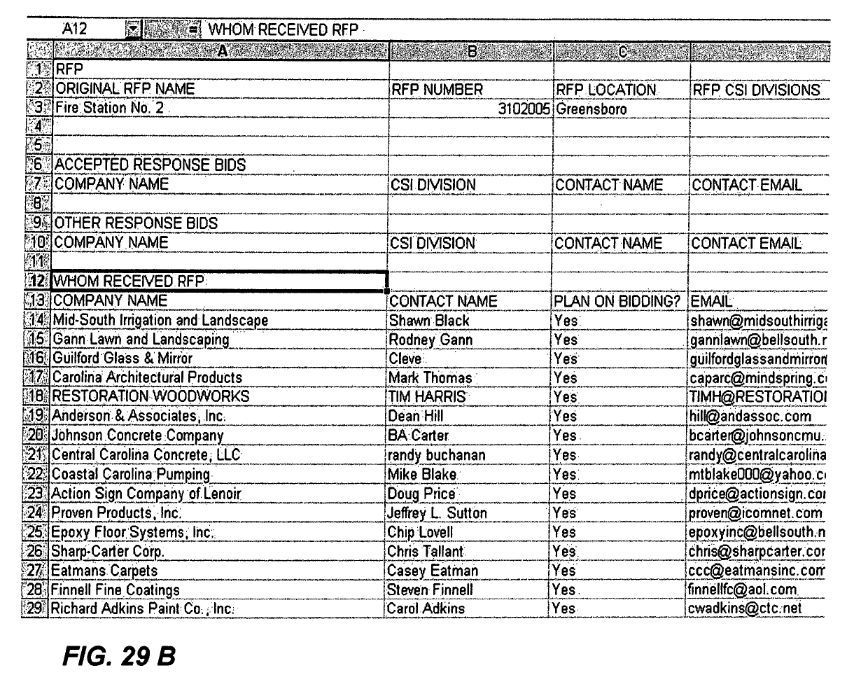

Turning now to FIG. 29A an example spreadsheet is provided which exemplifies a spreadsheet view of private bids. This view is similar to other spreadsheet views of bids or RFPs that can be generated using a bid system consistent with certain embodiments. In the present embodiment, the user can navigate to this right from the bid listing panel. A spreadsheet view in Excel™ format is depicted in FIG. 29B.

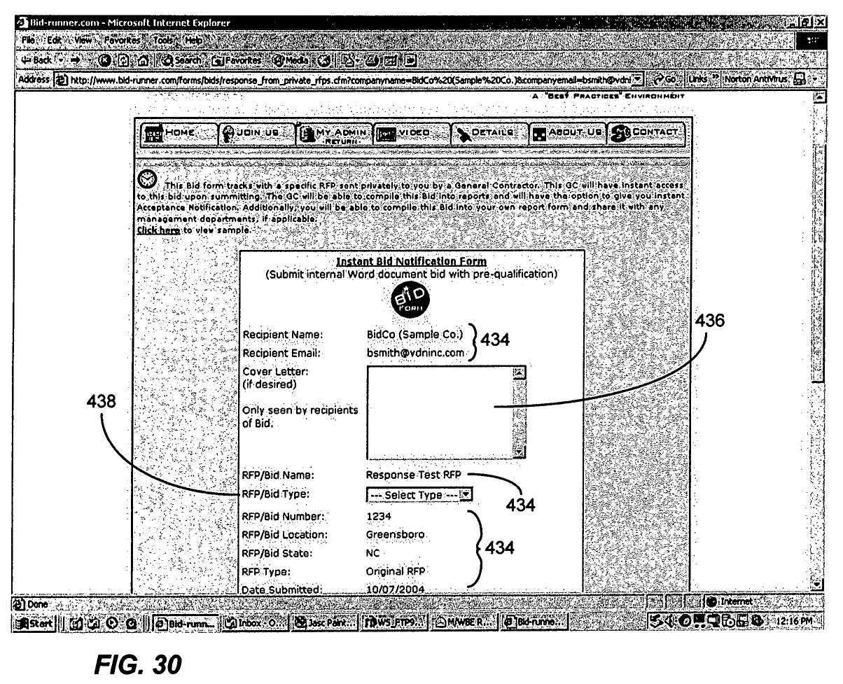

When a subcontractor or supplier wishes to respond to a bid that has been received, he/she indicates that desire by selecting, for example, the “respond with bid” selection shown in area 412 of FIG. 26. This takes the user to a screen such as that of FIG. 30 which is an exemplary bid response form consistent with certain embodiments. Upon entry to this screen, RFP specific information is autopopulated in areas such as those designated 434 (e.g., bid number, GC name, etc.). The user can then enter a cover letter's text at area 436 and can select a bid type at section 438. In areas not shown in this view, but which are readily accessed by scrolling down, the user enters basic data regarding the response such as that shown in area 384 of FIG. 24 (i.e., bid amount, CSI codes, etc.). Additionally, the bid form is automatically linked to the bidding company's basic information, insurance certificate, logo and company description and photo. On this screen also (in certain embodiments) the user is provided a selection to attach a detailed bid document, in much the same manner that the GC was provided a selection to attach the RFP at 354 of FIG. 20. Once the bid response screen is completed, the user digitally signs the bid and sends it in a manner similar to that used by the GC in sending the RFP.

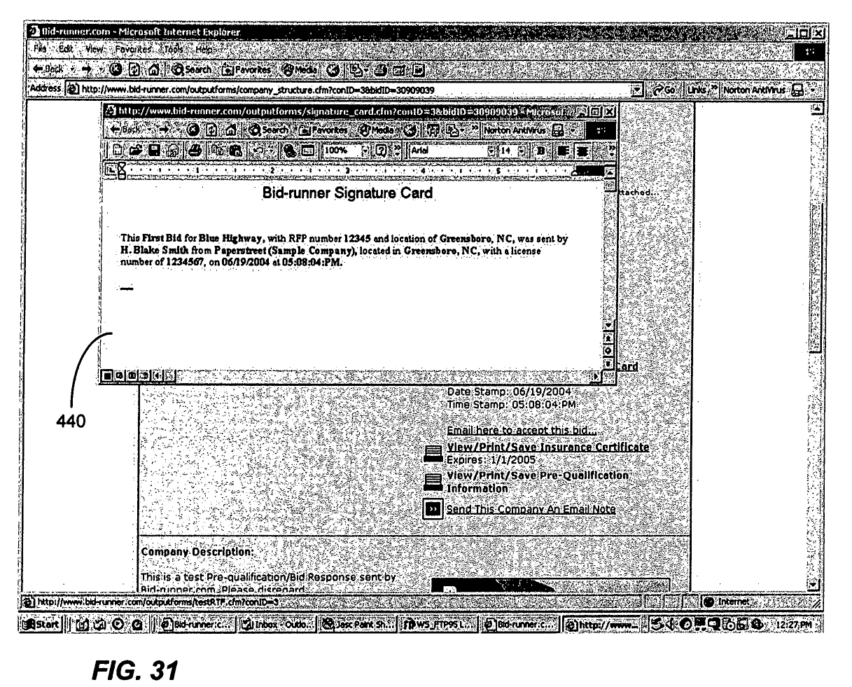

FIG. 31 is an illustrative screen shot showing a digital signature card associated with a particular bid in a manner consistent with certain embodiments of the present invention. In the present embodiment, the user can navigate to this location by clicking Signature Card link on the web output page. A GC's digital signature card associated with a particular RFP can be displayed in a similar manner.

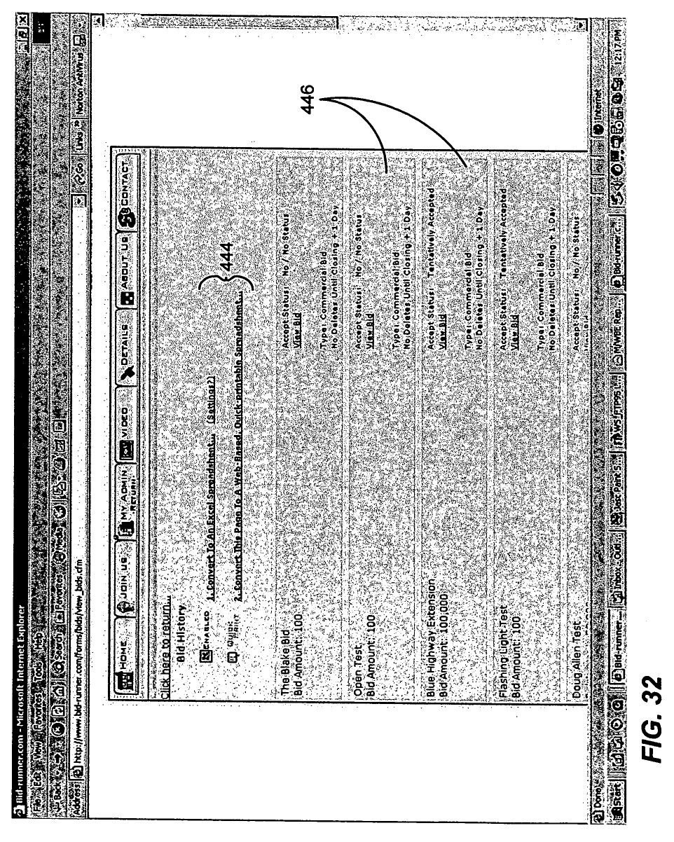

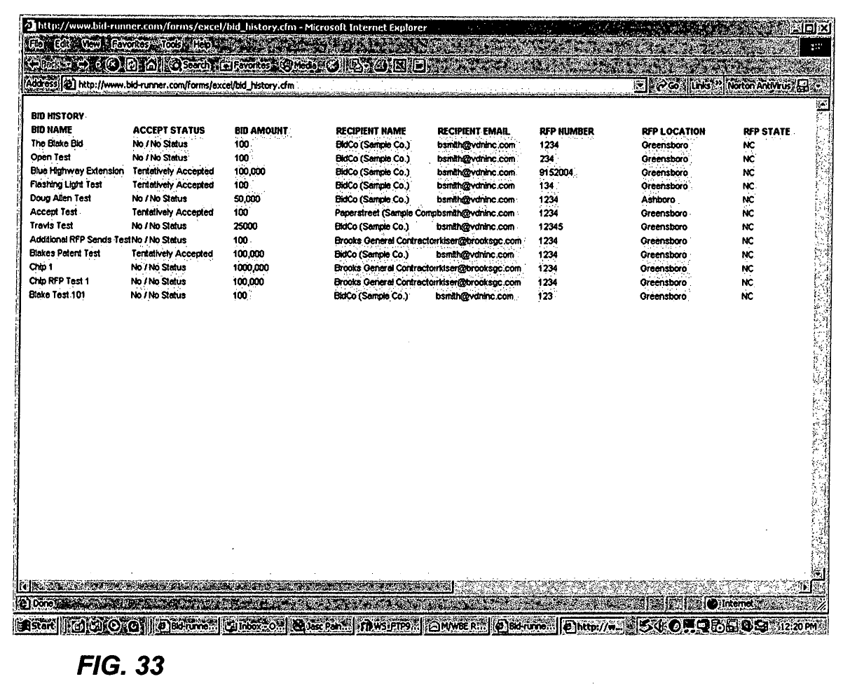

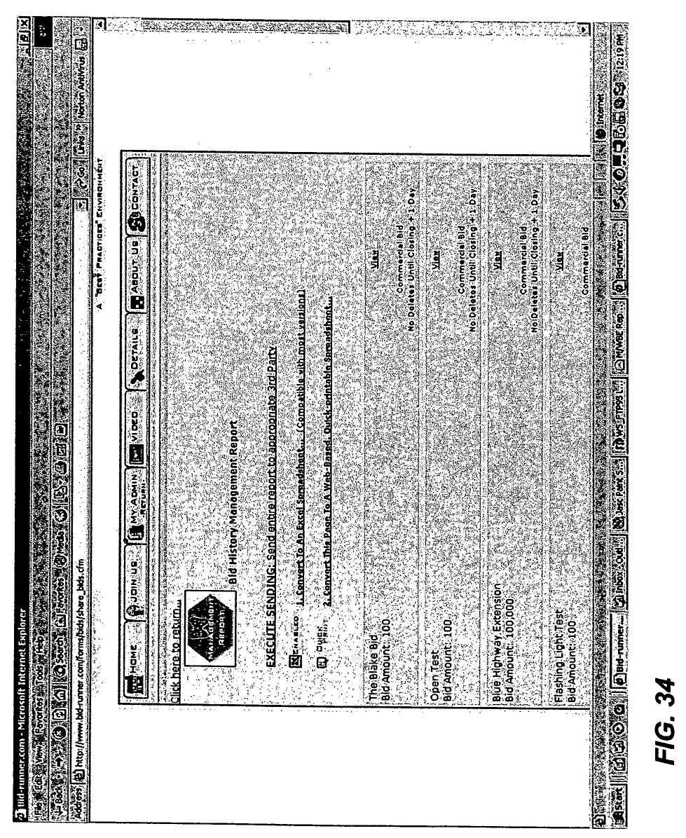

Just as a GC can view a bid history of outstanding RFPs, a subcontractor or supplier can similarly view a bid history of outstanding bids. FIG. 32 is an illustrative screen shot of a bid history for a subcontractor or supplier consistent with certain embodiments of the present invention. In the present embodiment, the user can navigate to this location by going to the BID section in their Admin Panel. The view can be converted to a spreadsheet view at 444, or can be viewed in the default format shown with an area such as 446 provided for each bid. By selecting a spreadsheet format view at 444, the user can view summarizing bid history information in a spreadsheet format such as that shown in FIG. 33. In the present embodiment, the user can navigate to this location by going to the Bid sending terminal and viewing the bid in the form of an Excel spreadsheet. FIG. 34 is an example of a bid history management report containing similar information that can be emailed, for example to a management entity to provide access to an overview as well as detailed bid history. In the present embodiment, the user can navigate to this location by use of a link from the bid sending terminal.

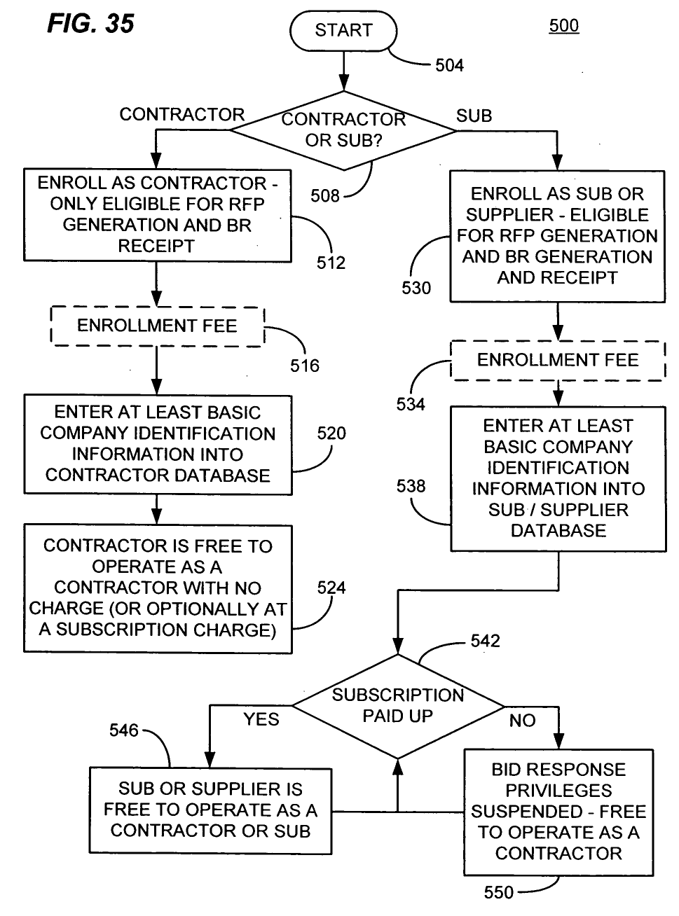

In accordance with the above description, a bid system is provided which is conducive to generation of income by the bid system operator. FIG. 35 depicts one illustrative process shown as 500 for generation of revenue by use of the bid system, starting at 504. In this bid system, a subscriber can enroll as either a contractor on the one hand or a subcontractor or supplier on the other as indicated at 508. As a general contractor, the subscriber follows the left hand path and as a subcontractor or supplier the subscriber follows the right hand path. For purposes of this drawing, the only distinction is the ability to respond to RFPs.

If a subscriber enrolls only as a GC, the subscriber enrolls at 512 with only the ability to generate RFPs and receive bid responses. At 516, the subscriber may optionally be charged an enrollment fee, and the subscriber can then begin the process of entry of basic company identification information at any tine at 520. The subscriber/general contractor is then free to post RFPs without charge in one embodiment (in order to generate activity for RBs from subcontractors and suppliers that are required to pay a subscription fee). In other embodiments, the GC could be charged a fee either based upon submissions of RFPs, or by giving them the ability to send Response Bids, as some do, or a periodic usage fee without limitation.

If a subscriber enrolls as a supplier or subcontractor at 530, the company can use the bid system for both RFPs and response bids. This can be significant for those General Contractors who subcontract when out of their particular geographic, or expertise areas, especially in the Heavy Highway Construction Industry; where, for example, a company might produce asphalt and may supply this to other firms who are acting as the GC on that particular project. The subscriber may similarly be charged an optional enrollment fee at 534, and can similarly enter basic company identification information at any time at 538. So long as the subscriber's subscription is paid up at 542, the subscriber can operate as either a GC, a subcontractor or supplier at 546. Failure to maintain payments of the subscription fee at 542 can result in suspension of privileges. In one embodiment, all privileges are terminated, while in others, only the privilege of responding to bids is terminated. Upon consideration of the present teachings, those skilled in the art will appreciate many variations on the present embodiments.

Certain embodiments consistent with the present invention are particularly useful in management of the government RFP and RB process. Currently, many government RFPs arbitrarily require certain percentages of work on their contracts to be carried out by disadvantaged businesses. The goal of such activities is to assure that disadvantaged businesses have ample opportunity to grow themselves into mainstream operations that are self sufficient and thriving. Unfortunately, heretofore there has been no good way to either determine what percentage is an appropriate requirement for government contracts and there has been no way of measurement of a contractor's good faith efforts to comply. Compliance has also been expensive and burdensome in the past due to the need to send large volumes of mailed RFPs and/or make large numbers of telephone calls. Moreover, there has been no way to measure the effectiveness of programs designed to encourage use of disadvantaged business enterprises.

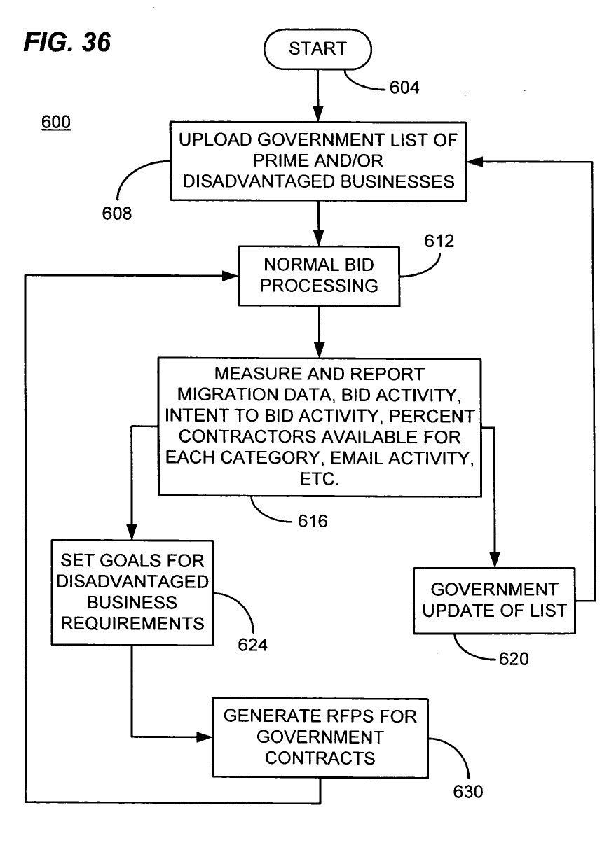

FIG. 36 depicts a process 600 used in conjunction with certain embodiments of the present bid system starting at 604, which is particularly well suited to use for government contracts in order to encourage development of disadvantaged businesses. At 608, government entities (i.e., a state department of transportation) provide a list of disadvantaged businesses and a list of prime contractors (i.e., approved general contractors) that can be uploaded at 608 into the bid system. This permits GCs to readily send out RFPs to contractors that are on the appropriate government lists to assure good faith compliance using the RFP dissemination processes described above. The normal bidding process as previously described can then be carried out at 612.

On a periodic or demand basis, the bid system can run statistical reports at 616 that are then useful to the government entity to determine if the disadvantaged businesses are responding to bids and are migrating to GC lists of subcontractors. These reports can be used to measure the success of a particular program in achieving the goal of making disadvantaged businesses more visible, and encourage utilization of such businesses. In one embodiment, the bid activity for each disadvantaged business including intents to bid, actual bids, email activity, etc. can be measured to determine that they are actively seeking to respond to RFPs and obtain work. Those that are consistently not doing so can be removed from the disadvantaged business list. In a similar manner, those businesses that are receiving substantial volumes of work, may no longer be considered disadvantaged. The lists can be updated at 620 by the appropriate government agency to reflect such changes.

As the list of disadvantaged businesses is refined as described above, and the percentages of such businesses that are active becomes better known, the government agency can refine goals for disadvantaged businesses at 624 for future government RFPs generated at 630. Simultaneously, the prime contractors and general contractors work effort required to comply with good faith effort requirements is dramatically simplified. Moreover, the success of a program for improving utilization of disadvantaged businesses can be measured by historical tracking of the migration of disadvantaged contractors from the government lists to private GC lists.

In one embodiment, such statistics can be provided readily by accessing a statistics button after the government entity logs into the system. Many other statistics can be readily compiled also for use by government entities. The government entity can readily retrieve a list of all disadvantaged businesses and determine how many RFPs have gone to each and whether they responded and how.

Thus, certain embodiments consistent with the present invention are particularly well suited to assuring that disadvantaged businesses receive a fair opportunity to bid on RFPs. In such a web based centralized electronic bidding system, consistent with certain embodiments of the present invention has a database manager that stores government agency Prime and disadvantaged subcontractor and supplier company identification information in a database and a bid processor. A program permits a government agency to log into a specified section of the electronic bidding system. The bid processor retrieves data pertaining to Prime contractors and listed disadvantaged businesses, wherein response bid (RB) and Request for Proposal (RFP) data are associated with a specified government approved contractor.

In such a system the bid processor can compile historical data on those contractors that have received bids and the contractor's bid activity. Moreover, the bid server system can compile specified contractor migration data, that tracks movement of a disadvantaged contractor into a general contractor's private database. This allows notification of projects that are non-mandated as “Good Faith” necessary jobs. For the first time, agencies are able to move from a “task oriented” format, i.e., placing all of the financial and time resources on the general contractor to verify “Good Faith” in notifying subcontractors of RFPs, which has traditionally been done by fax, phone, stamped mail, etc., without much verification, to a “goal oriented” format. This change is consistent with the ultimate goal of the M/WBE and DBE and other disadvantaged business promotion programs to work opportunities to underutilized businesses, without creating more expensive and time-consuming tasks for general contractors.

In such a system, the bid server system can further provide data on which disadvantaged businesses are responding to RFPs, and can provide a mechanism for uploading government supplied lists of disadvantaged businesses into a database which can then be used by contractors to assure compliance with government regulations. The migration data can be compared with disadvantaged businesses are to mandated/required M/WBE and DBE reports, later in the process, for government agencies. In combination, these aspects of government agency reporting, i.e., intent to bid, migration statistics, and M/WBE and DBE reports allow government agencies to analyze whether, or not particular programs are effective, and can result in a large impact on agencies at the State and Federal level.

It should be noted that the above description often uses a commercial embodiment marketed as the Bidrunner™ system as an exemplary embodiment. However, the details described above may not be present in all potential embodiments consistent with the present invention. Upon consideration of the present teachings, many variations are possible without departing from the invention.

Thus, a method of providing disadvantaged contractor migration data consistent with certain embodiments involves storing data in a database identifying disadvantaged business entities; storing data in the database identifying non-disadvantaged business entities; storing a contact list for each of the non-disadvantaged business entities, the contact list being maintained by the non-disadvantaged business entity; and measuring a migration of data identifying disadvantaged business entities into the contact list of a non-disadvantaged business entity. In certain embodiments, the method further involves generating a report identifying each disadvantaged business entity and a number of migrations to non-disadvantaged business entity's contact list for each disadvantaged business entity. In certain embodiments, the method further involves generating a report identifying bid or intent to bid activity for each of the disadvantaged business entities.

Those skilled in the art will recognize, upon consideration of the above teachings, that certain of the above exemplary embodiments are based upon use of a programmed processor. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Thus, in accordance with one embodiment consistent with the present invention, a method of distributing a Request for Proposals (RFPs) from a contractor to subscribing recipients involves providing a bid server system having a centralized database and a centralized file server; storing contractor identifying information in the centralized database; storing the RFP as an electronic file in a centralized file server; assembling a list of selected subscribing recipients of the RFP from the centralized database of subscribing recipients; associating the RFP with the contractor identifying information in a dynamically created web page; and sending a network notification of the RFP to the list of selected subscribing recipients, the notification being available when a selected subscribing recipient logs on to the bid server system and providing a link to the dynamically created web page, so that the selected subscribing recipients can access the RFP and associated contractor identifying information.

A method of responding, or letting a General Contractor know a subcontractor's intent to bid on a Request for Proposals (RFPs) with a Response Bid (RB) from a subscriber to a contractor consistent with certain embodiments of the present invention involves providing a bid server system having a centralized database and a centralized file server; storing subscriber identifying information in the centralized database; storing the RB file as an electronic file in a centralized file server; associating the RB file with an identifier of the RFP and with the subscriber identifying information as a bid response package in a dynamically created web page; and sending a network notification of the RB to the contractor, the notification being available when the contractor logs on to the bid server system and providing a link to the dynamically created web page, so that the contractor can access the RB and associated subscriber identifying information.

A method for a contractor to receive and manage responses to a Request for Proposals (RFPs) from subscribing recipients consistent with certain embodiments involves providing a bid server system having a centralized database and a centralized file server; storing contractor identifying information in the centralized database; storing the RFP as an electronic file in a centralized file server; receiving and storing Response Bids (RBs) from subscribing recipients; storing a database of subscribing recipients at a centralized database of subscribing recipients; dynamically creating a web page associated with the RFP which displays a summary of RBs, wherein the summary contains basic information regarding each RB received in response to the RFP; and for each RB, providing links in the dynamically created web page to a RB file containing RB details.

A construction bidding process consistent with certain embodiments involves enrolling contractors to use an electronic bidding system, wherein the contractors may post Requests for Proposals (RFPs) electronically, the electronically posted RFPs incorporating contractor information as well as links to an electronically stored RFP file with RFP details, wherein the posted RFPs are assembled from a database of contractor information and the stored RFP file; enrolling subscribers who pay a subscription fee, to use the bidding system in order to respond to posted RFPs with Response Bids (RBs), wherein the RB incorporates subscriber information as well as links to an electronically stored RB file with RB details, wherein the posted RBs are assembled from a database of subscriber information and the stored RB file.

A web based centralized electronic bidding system for construction bidding consistent with certain embodiments of the present invention has a database manager that stores contractor and subcontractor and supplier company identification information in a database and a bid processor. A program permits any of the contractor, subcontractor and supplier to log onto the electronic bidding system. The bid processor receives a Requests for Proposals (RFP) document submitted electronically by a logged on contractor, assigns an identifier to the RFP document and associates the RFP document with company identifying information for the contractor that submitted the RFP document, to create a virtual RFP. A contact manager permits the logged on contractor to select at least one subcontractor or supplier for receipt of the virtual RFP. The bid processor further sends a notification to the selected subcontractor or supplier, so that the subcontractor or supplier will be notified of receipt of the virtual RFP upon logging on to the electronic bidding system.

Another web based centralized electronic bidding system for construction bidding consistent with certain embodiments of the present invention has a database manager that stores contractor and subcontractor and supplier company identification information in a database and a bid processor. A program permits any of the contractor, subcontractor and supplier to log onto the electronic bidding system. The bid processor receives a Response Bid (RB) document submitted electronically by a logged on subcontractor or supplier, assigns an identifier to the RB document and associates the RB document with company identifying information for the subcontractor or supplier that submitted the RB document, to create a virtual RB. The RB is a response to a Request for Proposals (RFP) associated with a specified contractor. The bid processor further sends a notification to the specified contractor, so that the contractor will be notified of receipt of the virtual RB upon logging on to the electronic bidding system.

The above arrangement for a user interface and for the structure of links and features are to be considered illustrative only, and are based upon the exemplary Bidrunner™ embodiment. Other embodiments may use any or all of these features and/or may contain additional features without departing from embodiments consistent with the present invention.

Those skilled in the art will appreciate, upon consideration of the above teachings, that the program operations and processes and associated data used to implement certain of the embodiments described above can be implemented using disc storage as well as other forms of storage such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments of the present invention. Such alternative storage devices should be considered equivalents.

Software and/or firmware embodiments may be implemented using a programmed processor executing programming instructions that in certain instances are broadly described above in flow chart form that can be stored on any suitable electronic or computer readable storage medium (such as, for example, disc storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies) and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A method of distributing a Request for Proposals (RFPs) from a contractor to subscribing recipients, comprising:
providing a bid server system having a centralized database and a centralized file server;
storing contractor identifying information in the centralized database;
storing the RFP as an electronic file in a centralized file server;
assembling a list of selected subscribing recipients of the RFP from the centralized database of subscribing recipients;
associating the RFP with the contractor identifying information in a dynamically created web page; and
sending a network notification of the RFP to the list of selected subscribing recipients, the notification being available when a selected subscribing recipient logs on to the bid server system and providing a link to the dynamically created web page, so that the selected subscribing recipients can access the RFP and associated contractor identifying information.

2. The method according to claim 1, wherein the bid server system further comprises an email server, and further comprising sending a secondary email from the email server to the selected subscribing recipients as a secondary notification of the RFP.

3. The method according to claim 1, wherein the file server assigns a unique identifier to the RFP file and wherein the RFP file is associated with the contractor identifying information.

4. The method according to claim 1, further comprising at least one of digitally signing, time stamping and date stamping the RFP.

5. The method according to claim 1, wherein the web page includes a link to a planning room associated with the RFP.

6. A computer readable storage medium storing instructions that when executed on a programmed processor carry out the method according to claim 1.

7. A method of responding, or letting a General Contractor know a subcontractor's intent to bid on a Request for Proposals (RFPs) with a Response Bid (RB) from a subscriber to a contractor comprising:
providing a bid server system having a centralized database and a centralized file server;
storing subscriber identifying information in the centralized database;
storing the RB file as an electronic file in a centralized file server;
associating the RB file with an identifier of the RFP and with the subscriber identifying information as a bid response package in a dynamically created web page; and
sending a network notification of the RB to the contractor, the notification being available when the contractor logs on to the bid server system and providing a link to the dynamically created web page, so that the contractor can access the RB and associated subscriber identifying information.

8. The method according to claim 7, wherein the bid server system further comprises an email server, and further comprising sending a secondary email from the email server to the selected contractor as a secondary notification of the RB.

9. The method according to claim 7, further comprising storing subscriber prequalification information as a file in the file server, and associating the prequalification information with the bid response package in the dynamically created web page.

10. The method according to claim 7, further comprising storing a subscriber insurance certificate as a file in the file server, and associating the insurance certificate with the bid response package in the dynamically created web page.

11. The method according to claim 7, wherein the file server assigns a unique identifier to the RB file and wherein the RB file is associated with the subscriber identifying information.

12. The method according to claim 7, wherein the subscriber comprises at least one of a subcontractor and a supplier.

13. The method according to claim 7, further comprising at least one of digitally signing, time stamping and date stamping the bid response package.

14. A computer readable storage medium storing instructions that when executed on a programmed processor carry out the method according to claim 7.

15. A method for a contractor to receive and manage responses to a Request for Proposals (RFPs) from subscribing recipients, comprising:
providing a bid server system having a centralized database and a centralized file server;
storing contractor identifying information in the centralized database;
storing the RFP as an electronic file in a centralized file server;
receiving and storing Response Bids (RBs) from subscribing recipients;
storing a database of subscribing recipients at a centralized database of subscribing recipients;
dynamically creating a web page associated with the RFP which displays a summary of RBs, wherein the summary contains basic information regarding each RB received in response to the RFP; and
for each RB, providing links in the dynamically created web page to a RB file containing RB details.

16. The method according to claim 15, further comprising updating the dynamic creation of the web page at timed intervals.

17. The method according to claim 15, further comprising storing subscriber prequalification information as a file in the file server, and for each RB providing a link in the web page for accessing the prequalification information.

18. The method according to claim 15, further comprising storing a subscriber insurance certificate as a file in the file server, and for each RB providing a link in the web page for accessing the insurance certificate.

19. The method according to claim 15, further comprising storing information relating to disadvantaged status of subscribing recipients, and generating a report including information relating to the disadvantaged status of the subscribing recipients, whereby compliance with governmental regulations relating to disadvantaged contracting can be examined.

20. A computer readable storage medium storing instructions that when executed on a programmed processor carry out the method according to claim 15.

21. A construction bidding process, comprising
enrolling contractors to use an electronic bidding system, wherein the contractors may post Requests for Proposals (RFPs) electronically, the electronically posted RFPs incorporating contractor information as well as links to an electronically stored RFP file with RFP details, wherein the posted RFPs are assembled from a database of contractor information and the stored RFP file;
enrolling subscribers who pay a subscription fee, to use the bidding system in order to respond to posted RFPs with Response Bids (RBs), wherein the RB incorporates subscriber information as well as links to an electronically stored RB file with RB details, wherein the posted RBs are assembled from a database of subscriber information and the stored RB file.

22. The process according to claim 21, wherein the RB further includes a link to a file storing an electronic copy of the subscriber's insurance certificate.

23. The process according to claim 21, wherein the RB further includes a link to a file storing an electronic copy of the subscriber's pre-certification information.

24. The process according to claim 21, further comprising revoking a subscriber's privileges to submit RBs upon failure by the subscriber to pay a subscription fee.

25. A web based centralized electronic bidding system for construction bidding, comprising:
a database manager that stores contractor and subcontractor and supplier company identification information in a database;
a bid processor;
means for permitting any of the contractor, subcontractor and supplier to log onto the electronic bidding system;
wherein, the bid processor receives a Requests for Proposals (RFP) document submitted electronically by a logged on contractor, assigns an identifier to the RFP document and associates the RFP document with company identifying information for the contractor that submitted the RFP document, to create a virtual RFP;
a contact manager that permits the logged on contractor to select at least one subcontractor or supplier for receipt of the virtual RFP; and
the bid processor further sending a notification to the selected subcontractor or supplier, so that the subcontractor or supplier will be notified of receipt of the virtual RFP upon logging on to the electronic bidding system.

26. The system according to claim 25, wherein the bid server system further comprises an email server, and wherein a secondary email notification is sent from the email server to the selected subcontractor or supplier as a secondary notification of the RFP.

27. The system according to claim 25, wherein the virtual RFP comprises a dynamically created web page that links company information stored in the database to the RFP document.

28. The system according to claim 27, wherein the RFP document is accessed from the web page by a hyperlink.

29. The system according to claim 25, wherein the database manager, contact manager and bid processor comprise programmed processes carried out on one or more computers.

30. A web based centralized electronic bidding system for construction bidding, comprising:
a database manager that stores contractor and subcontractor and supplier company identification information in a database;
a bid processor;
means for permitting any of the contractor, subcontractor and supplier to log onto the electronic bidding system;
wherein, the bid processor receives a Response Bid (RB) document submitted electronically by a logged on subcontractor or supplier, assigns an identifier to the RB document and associates the RB document with company identifying information for the subcontractor or supplier that submitted the RB document, to create a virtual RB;
wherein the RB is a response to a Requests for Proposals (RFP) associated with a specified contractor; and
the bid processor further sending a notification to the specified contractor, so that the contractor will be notified of receipt of the virtual RB upon logging on to the electronic bidding system.

31. The system according to claim 30 wherein the bid server system further comprises an email server, and wherein a secondary email notification is sent from the email server to the specified contractor as a secondary notification of the virtual RB.

32. The system according to claim 30, wherein, the bid processor further receives an insurance certificate document submitted electronically by a logged on subcontractor or supplier, assigns an identifier to the insurance certificate document and associates the insurance certificate document with company identifying information for the subcontractor or supplier that submitted the RB document, as a part of the virtual RB.

33. The system according to claim 30, wherein the virtual RB comprises a dynamically created web page that links company information about the subcontractor or supplier stored in the database to the RB document.

34. The system according to claim 33, wherein the RB document is accessed from the web page by a hyperlink.

35. The system according to claim 30, wherein the database manager, contact manager and bid processor comprise programmed processes carried out on one or more computers.

36. A web based centralized electronic bidding system, comprising:
a database manager that stores government agency Prime and disadvantaged subcontractor and supplier company identification information in a database;
a bid processor;
means for permitting a government agency to log into a specified section of the electronic bidding system;
wherein, the bid processor retrieves data pertaining to Prime contractors and listed disadvantaged businesses; and
wherein the bid processor reports response bid (RB) and Request for Proposal (RFP) data associated with a specified government approved contractor.

37. The system according to claim 36, wherein the bid processor further compiles historical data on those contractors that have received bids and the contractor's bid activity

38. The system according to claim 36, wherein the bid server system further compiles specified contractor migration data, that tracks movement of a disadvantaged contractor into a general contractor's private database.

39. The system according to claim 36, wherein the bid server system further comprising means for providing data on which disadvantaged businesses are responding to RFPs.

40. The system according to claim 36, wherein the bid server system further comprises means for uploading government supplied lists of disadvantaged businesses into a database.

41. A method of providing disadvantaged contractor migration data, comprising:
storing data in a database identifying disadvantaged business entites;
storing data in the database identifying non-disadvantaged business entities;
storing a contact list for each of the non-disadvantaged business entities, said contact list being maintained by the non-disadvantaged business entity; and
measuring a migration of data identifying disadvantaged business entities into the contact list of a non-disadvantaged business entity.

42. The method according to claim 41, further comprising generating a report identifying each disadvantaged business entity and a number of migrations to non-disadvantaged business entity's contact list for each disadvantaged business entity.

43. The method according to claim 41, further comprising generating a report identifying bid or intent to bid activity for each of the disadvantaged business entities.
